(19) United States
(12) Patent Application Publication
(10) Pub. No.: US 2026/0360299 A1
(43) Pub. Date: Nov. 12, 2026

(54) ELECTRONIC DEVICE, METHOD, AND NON-TRANSITORY COMPUTER-READABLE STORAGE MEDIUM FOR CONTROLLING DISPLAY

(71) Applicant: Samsung Electronics Co., Ltd., Suwon-si (KR)

(72) Inventors: Jaesung LEE, Suwon-si (KR); Kyounghwan KWON, Suwon-si (KR); Siwoo KIM, Suwon-si (KR); Jongkon BAE, Suwon-si (KR); Byungduk YANG, Suwon-si (KR); Woonyoung LEE, Suwon-si (KR)

(21) Appl. No.: 19/715,191

(22) Filed: Jun. 22, 2026

Related U.S. Application Data
(63) Continuation of application No. PCT/KR2024/016327, filed on Oct. 24, 2024.

(30) Foreign Application Priority Data
Dec. 24, 2023 (KR) 10-2023-0190573
Feb. 6, 2024 (KR) 10-2024-0018355

(51) Int. Cl. G09G 3/20

(52) U.S. Cl. CPC G09G 3/2096; G09G 2354/00; G09G 2360/08; G09G 2360/12; G09G 2370/045

(57) ABSTRACT

An electronic device is provided. The electronic device includes a display including a display driving circuit and a display panel, memory, comprising one or more storage media, storing instructions, at least one processor comprising processing circuitry communicatively coupled to the display and the memory, wherein the instructions, when executed by the at least one processor individually or collectively, cause the electronic device to while a first image is displayed on the display panel, generate a notification for image transmission to the display driving circuit to be executed from a first start time different from a second start time determined according to a frame interval, generate a command according to the notification, and control, according to the command, the display driving circuit to complete repeated displaying of the first image on the display panel before data for a second image is transmitted to the display driving circuit through the image transmission executed from the first start time.

### CROSS-REFERENCE TO RELATED APPLICATION(S)

This application is a continuation application, claiming priority under 35 U.S.C. § 365(c), of an International application No. PCT/KR 2024/016327, filed on Oct. 24, 2024, which is based on and claims the benefit of a Korean patent application number 10-2023-0190573, filed on Dec. 24, 2023, in the Ministry of Intellectual Property (MOIP), and of a Korean patent application number 10-2024-0018355, filed on Feb. 6, 2024, in the Ministry of Intellectual Property (MOIP), the disclosure of each of which is incorporated by reference herein in its entirety.

### BACKGROUND

### 1. Field

The disclosure relates to an electronic device, a method, and a non-transitory computer-readable storage medium for controlling a display.

### 2. Description of Related Art

An electronic device may include a display and a processor. The display may be used for displaying an image generated (or obtained) by the processor. For example, an image transmission from the processor to the display may be executed for a display of the image.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, a method, and a non-transitory computer-readable storage medium for controlling a display.

Additional aspects will be set forth in part in the description which follows and, in part, will be apparent from the description, or may be learned by practice of the presented embodiments.

In accordance with an aspect of the disclosure, an electronic device is provided. The electronic device includes a display including display driving circuitry and a display panel, memory, comprising one or more storage media, storing instructions, at least one processor comprising processing circuitry communicatively coupled to the display and the memory, wherein the instructions, when executed by the at least one processor individually or collectively, cause the electronic device to while a first image is displayed on the display panel, generate a notification for an image transmission to the display driving circuitry to be executed from a first start time different from a second start time that is determined according to a frame interval, generate a command according to the notification, and control, according to the command, the display driving circuitry to complete, before data for a second image is transmitted through the image transmission executed from the first start time to the display driving circuitry, a repeated display of the first image on the display panel.

In accordance with another aspect of the disclosure, a method performed by an electronic device with a display including display driving circuitry and a display panel is provided. The method includes while a first image is displayed on the display panel, generating a notification for an image transmission to the display driving circuitry to be executed from a first start time different from a second start time that is determined according to a frame interval, generating a command according to the notification, and controlling, according to the command, the display driving circuitry to complete, before data for a second image is transmitted through the image transmission executed from the first start time to the display driving circuitry, a repeated display of the first image on the display panel.

In accordance with another aspect of the disclosure, one or more non-transitory computer-readable storage media storing one or more computer programs including computer-executable instructions that, when executed by one or more processors of an electronic device with a display including display driving circuitry and a display panel individually or collectively, cause the electronic device to perform operations are provided. The operations include while a first image is displayed on the display panel, generating a notification for an image transmission to the display driving circuitry to be executed from a first start time different from a second start time that is determined according to a frame interval, generate a command according to the notification, and controlling, according to the command, the display driving circuitry to complete, before data for a second image is transmitted through the image transmission executed from the first start time to the display driving circuitry, a repeated display of the first image on the display panel.

In accordance with another aspect of the disclosure, an electronic device is provided. The electronic device includes a display including display driving circuitry and a display panel, memory, comprising one or more storage media, storing instructions. The at least one processor is individually or collectively configured to generate, while a first image is displayed on the display panel, a notification for an image transmission to the display driving circuitry to be executed from a first start time different from a second start time that is determined according to a frame interval. The at least one processor is individually or collectively configured to generate a command according to the notification. The at least one processor is individually or collectively configured to control, according to the command, the display driving circuitry to refrain from performing, before data for a second image is transmitted through the image transmission executed from the first start time to the display driving circuitry, a repeated display of the first image on the display panel.

In accordance with another aspect of the disclosure, a method performed by an electronic device with a display including display driving circuitry and a display panel is provided. The method includes while a first image is displayed on the display panel, generating a notification for an image transmission to the display driving circuitry to be executed from a first start time different from a second start time that is determined according to a frame interval, generating a command according to the notification, and controlling, according to the command, the display driving circuitry to refraining from performing, before data for a second image is transmitted through the image transmission executed from the first start time to the display driving circuitry, a repeated display of the first image on the display panel.

In accordance with another aspect of the disclosure, one or more non-transitory computer-readable storage media storing one or more computer programs including computer-executable instructions that, when executed by one or more processors of an electronic device with a display including display driving circuitry and a display panel individually or collectively, cause the electronic device to perform operations are provided. The operations include generating, while a first image is displayed on the display panel, a notification for an image transmission to the display driving circuitry to be executed from a first start time different from a second start time that is determined according to a frame interval. The operations include generating a command according to the notification. The operations include instructions controlling, according to the command, the display driving circuitry to refrain from performing, before data for a second image is transmitted through the image transmission executed from the first start time to the display driving circuitry, a repeated display of the first image on the display panel.

In accordance with another aspect of the disclosure, an electronic device is provided. The electronic device includes a display including display driving circuitry and a display panel, memory, comprising one or more storage media, storing instructions, at least one processor comprising processing circuitry coupled to the display and the memory, wherein the instructions, when executed by the at least one processor individually or collectively cause the electronic device to while a first image is displayed on the display panel, generate a notification for an image transmission to the display driving circuitry to be executed from a first start time different from a second start time that is determined according to a frame interval, based on the notification generated outside a reference time interval from the first start time, generate a first command according to the notification and control, according to the first command, the display driving circuitry to complete, before data for a second image is transmitted through the image transmission executed from the first start time to the display driving circuitry, a repeated display of the first image on the display panel, and based on the notification generated within the reference time interval from the first start time, generate a second command according to the notification and control, according to the second command, the display driving circuitry to refrain from performing, before the data for the second image is transmitted through the image transmission executed from the first start time to the display driving circuitry, the repeated display of the first image on the display panel.

In accordance with another aspect of the disclosure, a method is performed by an electronic device with a display including display driving circuitry and a display panel is provided. The method includes while a first image is displayed on the display panel, generating a notification for an image transmission to the display driving circuitry to be executed from a first start time different from a second start time that is determined according to a frame interval, based on the notification generated outside a reference time interval from the first start time, generating a first command according to the notification and controlling, according to the first command, the display driving circuitry to complete, before data for a second image is transmitted through the image transmission executed from the first start time to the display driving circuitry, a repeated display of the first image on the display panel, and based on the notification generated within the reference time interval from the first start time, generating a second command according to the notification and controlling, according to the second command, the display driving circuitry to refrain from performing, before the data for the second image is transmitted through the image transmission executed from the first start time to the display driving circuitry, the repeated display of the first image on the display panel.

In accordance with another aspect of the disclosure, one or more non-transitory computer-readable storage media storing one or more computer programs including computer-executable instructions that, when executed by one or more processors of an electronic device with a display including display driving circuitry and a display panel individually or collectively, cause the electronic device to perform operations are provided. The operations include while a first image is displayed on the display panel, generating a notification for an image transmission to the display driving circuitry to be executed from a first start time different from a second start time that is determined according to a frame interval, based on the notification generated outside a reference time interval from the first start time, generating a first command according to the notification and controlling, according to the first command, the display driving circuitry to complete, before data for a second image is transmitted through the image transmission executed from the first start time to the display driving circuitry, a repeated display of the first image on the display panel, and based on the notification generated within the reference time interval from the first start time, generating a second command according to the notification and controlling, according to the second command, the display driving circuitry to refrain from performing, before the data for the second image is transmitted through the image transmission executed from the first start time to the display driving circuitry, the repeated display of the first image on the display panel.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a simplified block diagram of an electronic device according to an embodiment of the disclosure;

FIGS. 2, 3, 4, and 5 illustrate a method for processing a repeated display of a first image according to a notification for a second image based on a first mode according to various embodiments of the disclosure;

FIG. 6 illustrates a method for processing a repeated display of a first image according to a notification for a second image based on a second mode according to an embodiment of the disclosure;

FIGS. 7 and 8 illustrate a method for processing a repeated display of a first image according to a notification for a second image based on a third mode according to various embodiments of the disclosure;

FIGS. 9, 10, 11, 12, and 13 illustrate a method for processing a repeated display of a first image according to a notification for a second image based on a fourth mode according to various embodiments of the disclosure;

FIGS. 14, 15, and 16 illustrate a method for determining whether to transmit a command to display driving circuitry according to a state of a signal from the display driving circuitry to at least one processor according to various embodiments of the disclosure;

FIG. 17 is a block diagram of an electronic device in a network environment according to an embodiment of the disclosure; and

FIG. 18 is a block diagram of a display module according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

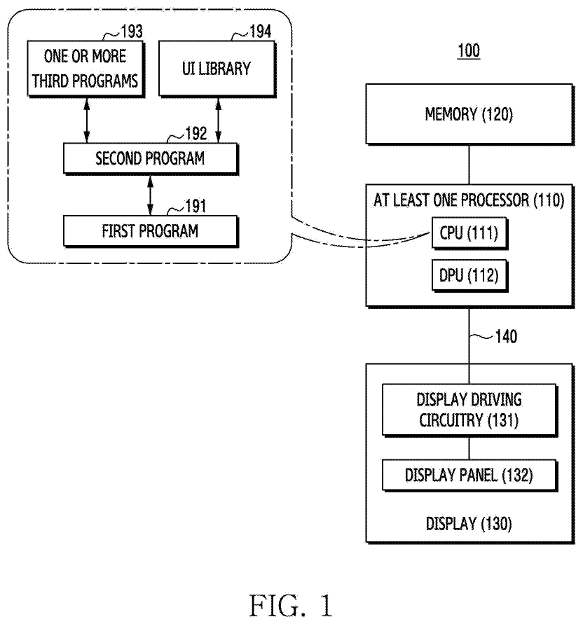

FIG. 1 is a simplified block diagram of an electronic device according to an embodiment of the disclosure.

Referring to FIG. 1, an electronic device 100 may be one of various types of electronic devices, such as a laptop, smartphones having various form factors (e.g., a bar type smartphone, a foldable type smartphone, or a slidable (or rollable) type smartphone), a tablet, a cellular phone, and other similar computing devices. Components illustrated in FIG. 1, their relationships, and their functions are merely exemplary, and do not limit implementations described or claimed in the document. The electronic device 100 may be referred to as a mobile device, a user device, a multi-function device, a portable device, or a server.

The electronic device 100 may include at least one processor 110, memory 120, and a display 130. The components (e.g., the at least one processor 110, the memory 120, and the display 130) are merely exemplary. For example, the electronic device 100 may include other components (e.g., power management integrated circuitry (PMIC), or a rechargeable battery). For example, some components may be omitted from the electronic device 100. For example, some components may be integrated into a single component.

The at least one processor 110 may be implemented as one or more integrated circuitry (IC) chips, and may execute various data processing. The at least one processor 110 may include at least one electrical circuitry, and may individually or collectively perform distributed processing of instructions (or programs, data, and the like) stored in the memory 120. The at least one processor 110 may include a processor assembly including one or more processing circuitry. The at least one processor 110 may include any processing circuitry operable to control performance and operations of one or more components (e.g., the memory 120 and/or the display 130) of the electronic device 100. For example, the at least one processor 110 (e.g., an application processor (AP)) may be implemented as a system on chip (SoC) (e.g., a single chip or a single chip set). For example, the at least one processor 110 may be implemented as multiple cores (or multiple core circuitry), multiple chips, or multiple chip sets. For example, the at least one processor 110 may include one or more processing circuitry configured to individually and/or collectively perform various functions of the disclosure. As a non-limiting example, the at least one processor 110 may include a first processor (e.g., including processing circuitry) included in a first chip and a second processor (e.g., including processing circuitry) included in a second chip different from the first chip.

For example, the at least one processor 110 may include a central processing unit (CPU) 111 (e.g., including processing circuitry) and a display processing unit (DPU) 112 (e.g., including processing circuitry). Components (e.g., the CPU 111 and the DPU 112) of the at least one processor 110 are merely exemplary. For example, the at least one processor 110 may further include other components (e.g., a memory controller (or memory control circuitry) for the memory 120 and a storage controller (or storage control circuitry) for the memory 120). For example, a portion (e.g., the DPU 112) of the components of the at least one processor 110 may be omitted from the at least one processor 110.

The at least one processor 110 may cause other components of the electronic device 100 to perform various operations by executing instructions stored in the memory 120. For example, the CPU 111 (or central processing circuitry 111) may be configured to control other components (e.g., the DPU 112) of the at least one processor 110 based on execution of instructions stored in the memory 120. For example, the DPU 112 (or display processing circuitry 112) may be configured to process an image obtained (or transmitted) from the CPU 111 in a format suitable for the display 130.

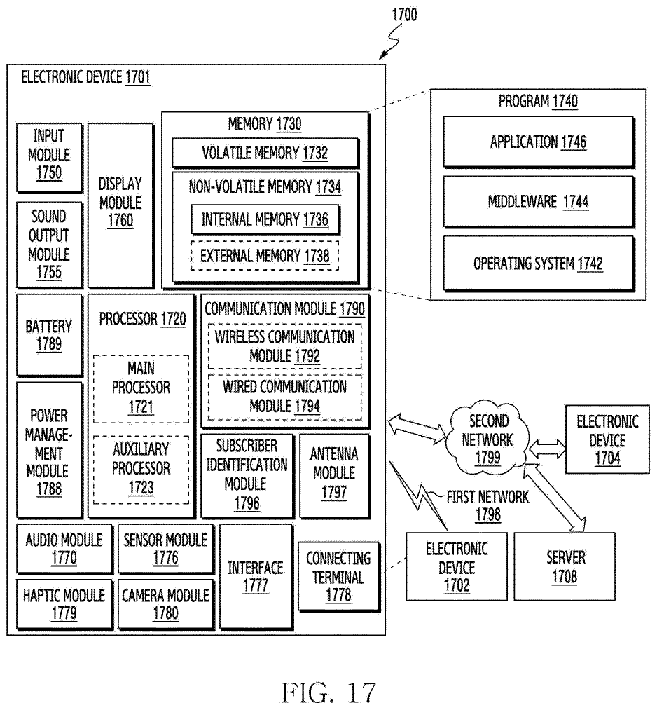

For example, the at least one processor 110 may include at least a portion of a processor 1720 of FIG. 17 or may correspond to at least a portion of the processor 1720 of FIG. 17.

The memory 120 may include one or more storage media (or one or more storage devices). For example, the memory 120 may include a memory assembly including one or more storage media. For example, the one or more storage mediums may include permanent memory such as a hard drive, flash memory, or read-only memory (ROM), semi-permanent memory such as random access memory (RAM), any other suitable type of storage (or storage assembly), or any combination thereof. The memory 120 may include cache memory, which is one or more different types of memory used to temporarily store data for a function (or a feature) of the electronic device 100. As a non-limiting example, the cache memory may be included in the processor 110. The memory 120 may be fixedly embedded in the electronic device 100 or may be incorporated onto one or more suitable types of components that may be repeatedly inserted into the electronic device 100 and removed from the electronic device 100 (e.g., a subscriber identity module (SIM) card and/or a secure digital (SD) card).

For example, the memory 120 may store one or more software applications such as an operating system (or a system software application), a firmware software application, a driver software application, a plugin (e.g., an add-in, an add-on, and/or an applet) software application, and/or any other suitable software applications. For example, the one or more software applications may include instructions executable by the at least one processor 110. For example, the memory 120 may store instructions callable by an application programming interface (API). For example, the memory 120 may store instructions in a library.

For example, the memory 120 may store a first program 191 included in a hardware abstraction layer (HAL) for controlling the display 130 and a second program 192 included in a framework layer for controlling the display 130. For example, the first program 191 may include instructions for executing (or performing) at least a portion of operations to be exemplified below. For example, the second program 192 may include instructions for executing (or performing) at least another portion of operations to be exemplified below. As a non-limiting example, each of the first program 191 and the second program 192 may be executable by the CPU 111 among the CPU 111 and the DPU 112.

For example, memory 120 may store one or more third programs 193 for generating at least a portion of images displayed on the display panel 132 and a user interface (UI) library 194 used for generating at least another portion of the images different from the at least a portion of the images generated by the one or more third programs 193. For example, the one or more third programs 193 may include a software application for gaming. As a non-limiting example, the one or more third programs 193 may generate the at least a portion of the images without use of the UI library 194. For example, the UI library 194 may be referred to as a UI toolkit or a user experience (UX) toolkit. For example, the UI library 194 may be used to set visual objects in a user interface provided from other programs (not illustrated) different from the one or more third programs and/or a movement of the visual objects. The one or more third programs 193 and the UI library 194 may determine a frame interval to be exemplified below. As a non-limiting example, the one or more third programs 193 may be executable by the CPU 111 among the CPU 111 and the DPU 112. As a non-limiting example, the UI library 194 may be used by the CPU 111.

For example, the memory 120 may include at least a portion of memory 1730 of FIG. 17 or may correspond to at least a portion of the memory 1730 of FIG. 17.

The display 130 may be used for a display of an image. The display 130 may include display driving circuitry 131 and a display panel 132 for the display of the image.

The display driving circuitry 131 may receive data for an image from the at least one processor 110 (or the DPU 112). The data may be transmitted, through an interface 140, from the at least one processor 110 (or the DPU 112) to the display driving circuitry 131. For example, the interface 140 (e.g., including at least one circuitry) may be usable for a first mode (e.g., a command mode of a mobile industry processor interface (MIPI) display serial interface (DSI)), a second mode (e.g., a video mode of the MIPI DSI), a third mode (e.g., a video hybrid mode of the MIPI DSI), and/or a fourth mode (e.g., an adaptive refresh panel (ARP) of the MIPI DSI) to be exemplified below. For example, the interface 140 may operate according to the first mode, operate according to the second mode, operate according to the third mode, and/or operate according to the fourth mode. As a non-limiting example, the interface 140 may include a mobile industry processor interface (MIPI) (or may support the MIPI).

The display driving circuitry 131 may display the image on the display panel 132 by scanning the image. For example, the display driving circuitry 131 may display the image on the display panel 132, by applying (or providing) a gate voltage and a source voltage to the display panel 132 through the scanning.

The display driving circuitry 131 may include graphic random access memory (GRAM) for the first mode and/or the third mode. For example, the GRAM may be used to (at least temporarily) store an image received from the at least one processor 110.

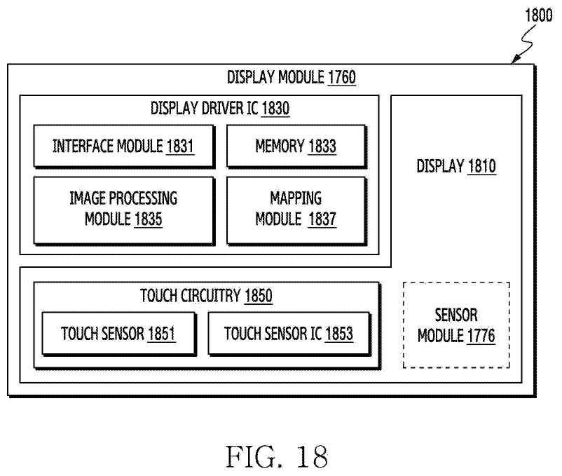

For example, the display driving circuitry 131 may include at least a portion of a display driver IC 1830 of FIG. 18 or may correspond to at least a portion of the display driver IC 1830 of FIG. 18.

The display panel 132 may display an image according to control of the display driving circuitry 131. For example, the display panel 132 may include sub-pixels. For example, each of the sub-pixels may include a driving transistor and a light-emitting element. For example, the display panel 132 may display an image according to a gate voltage and a source voltage from the display driving circuitry 131.

The at least one processor 110 may be configured for a changeable refresh rate (e.g., a variable refresh rate (VRR)). As a non-limiting example, the at least one processor 110 (or the CPU 111) may adaptively change a refresh rate for an image (e.g., an image to be displayed on the display panel 132) generated by the at least one processor 110 without considering a state of the display 130. For example, the at least one processor 110 may change a refresh rate at a time (or timing) (or time point) determined by the at least one processor 110 among the at least one processor 110 and the display 130. As a non-limiting example, the at least one processor 110 may adaptively change the refresh rate at the timing determined by the at least one processor 110 according to a light-emitting interval for displaying on the display panel 132 (e.g., a cycle of a light-emitting synchronization signal for the at least one processor 110) (or a timing of the light-emitting synchronization signal).

As a non-limiting example, changing the refresh rate at the time determined by the at least one processor 110 may not be predicted by the display 130. For example, since the time of changing the refresh rate may not be predicted by the display 130, a change of the refresh rate determined by the at least one processor 110 among the at least one processor 110 and the display 130 may interfere with operations executed by the display 130 among the at least one processor 110 and the display 130 for reducing afterimage (or image sticking, or image persistence) and/or flickering. For example, an unintended dual scan (or dual scan phenomenon) may be caused on the display panel 132 due to the change of the refresh rate interfering with the operations of the display 130 for reducing the afterimage and/or the flickering.

As a non-limiting example, a frame interval may be defined in the electronic device 100 to reduce the change of the refresh rate interfering with the operations of the display 130 for reducing the afterimage and/or the flickering. For example, the frame interval may be determined, defined, and/or obtained to execute an image transmission from the at least one processor 110 to the display driving circuitry 131 at a time (or timing) determined by the at least one processor 110 (e.g., the CPU 111) among the at least one processor 110 and the display 130. The frame interval may indicate a shortest time interval between times (or timings) (e.g., start times) (e.g., end times) for respectively generating images using the second program 192. For example, the frame interval may indicate a shortest time interval between image transmissions from the second program 192 to the first program 191. For example, the frame interval may indicate a shortest time interval between image transmissions from at least one processor 410 to display driving circuitry 431, which are executed to (newly) display an image on the display panel 132. For example, the frame interval may be indicated as the number of one or more emission periods available for providing a time capable of transmitting an image. For example, the frame interval may indicate a shortest time interval between image transmissions from the at least one processor 110 to the display driving circuitry 131, which are executed (or to be executed) for changing the image displayed on the display panel 132. For example, since the frame interval indicates the shortest time interval, a capability of at least one processor 110 capable of executing an image transmission at each start time of an emission period for each of pixels in the display panel 132 may be limited due to the frame interval. For example, since the frame interval indicates the shortest time interval, the display driving circuitry 131 may execute the operations for reducing the afterimage and/or the flickering within a time interval between an end time (or end timing) of a first image transmission (e.g., scheduled by the CPU 111) and a start time (or start timing) of a second image transmission (e.g., scheduled by the CPU 111) that may be executed after the first image transmission according to the frame interval.

For example, the at least one processor 110 may change a start time of the second image transmission that may be executed after the first image transmission. For example, the at least one processor 110 may change the start time of the second image transmission from a first start time determined according to the frame interval to a second start time before the first start time. As a non-limiting example, changing the start time of the second image transmission from the first start time to the second start time may be executed based on receiving an input (e.g., including receiving an input from a user of the electronic device 100 and/or receiving a signal from an external electronic device). For example, changing to the second start time changed from the first start time may not be predicted by the display 130 executing operations for reducing the afterimage and/or the flickering according to the frame interval. For example, since changing to the second start time changed from the first start time is not predicted by the display 130, the at least one processor 110 may generate a notification for the second image transmission (or an image to be transmitted to the display driving circuitry 131 through the second image transmission). For example, since the notification is generated before the second image transmission is executed, the notification may be referred to as an early present notification. As a non-limiting example, the at least one processor 110 may generate a command according to the notification. As a non-limiting example, the notification may be generated by the second program 192, and the command may be generated by the first program 191 that receives the notification from the second program 192. For example, the command may be used to process operations of the display 130 such that the operations of the display 130 for reducing the afterimage and/or the flickering according to the frame interval do not interfere with the second image transmission. For example, the command may be used to control the display 130 to process operations for reducing the afterimage and/or the flickering such that the operations do not interfere with the second image transmission.

For example, the at least one processor 110 may generate the notification for an image transmission to the display driving circuitry 131 to be executed from a first start time different from a second start time that is determined according to the frame interval, while a first image is displayed on the display panel 132. For example, the at least one processor 110 may generate a command according to the notification. For example, the at least one processor 110 may control the display driving circuitry 131 to complete, before data for a second image is transmitted to the display driving circuitry 131 through the image transmission executed from the first start time, a repeated display of the first image on the display panel 132, by using the command. For example, the command may be generated by the CPU 111. For example, controlling the display driving circuitry 131 may be executed based on transmitting the command from the CPU 111 through the DPU 112 to the display driving circuitry 131. For example, controlling the display driving circuitry 131 may be executed based on transmitting the command from the CPU 111 to the DPU 112.

For example, the at least one processor 110 may generate the notification for an image transmission to the display driving circuitry 131 to be executed from a first start time different from a second start time that is determined according to the frame interval, while a first image is displayed on the display panel 132. For example, the at least one processor 110 may generate a command according to the notification. For example, the at least one processor 110 may control the display driving circuitry 131 to refrain from performing, before data for a second image is transmitted to the display driving circuitry through the image transmission executed from the first start time, a repeated display of the first image on the display panel 132, by using the command. For example, the command may be generated by the CPU 111. For example, controlling the display driving circuitry 131 may be executed based on transmitting the command from the CPU 111 through the DPU 112 to the display driving circuitry 131. For example, controlling the display driving circuitry 131 may be executed based on transmitting the command from the CPU 111 to the DPU 112.

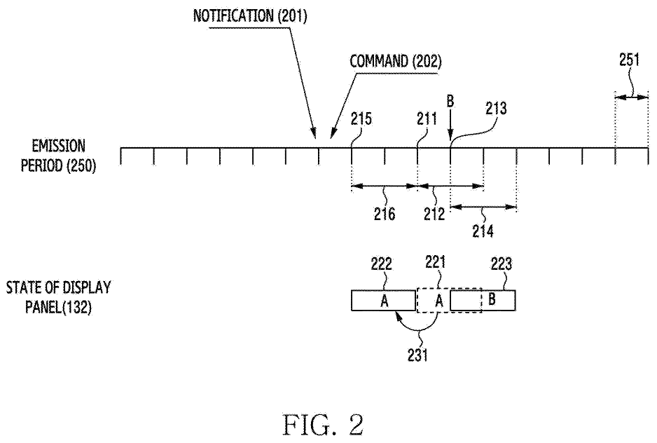

As a non-limiting example, controlling the display driving circuitry 131 through the command may be executed for an image transmission according to the first mode. This operation is exemplified in descriptions of FIGS. 2 to 5.

FIGS. 2 to 5 illustrate a method for processing a repeated display of a first image according to a notification for a second image based on a first mode according to various embodiments of the disclosure.

Referring to FIG. 2, the at least one processor 110 may generate a notification 201. For example, the notification 201 may be generated for an image B. For example, the notification 201 may be generated for an image B to be transmitted from the at least one processor 110 to the display driving circuitry 131, from a first start time 213 (or a first start timing 213) different from the second start time (or the second start timing) determined according to the frame interval. For example, the notification 201 may indicate a time (e.g., the first start time 213) starting an image transmission for the image B. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 may schedule a repeated display of the image A, as in a state 221. For example, the display driving circuitry 131 may determine (or schedule) to perform a scan of the image A for the repeated display of the image A within a time interval 212 from a time 211 that may complete the repeated display of the image A before the second start time determined according to the frame interval. As a non-limiting example, a length of the time interval 212 may be longer than a length 251 of an emission period 250 (e.g., corresponding to 240 hertz (Hz)). For example, the length of the time interval 212 may correspond to 120 (Hz). For example, the scan of the image A may be performed by reading the image A stored in the GRAM in the display driving circuitry 131. For example, the scan of the image A may be performed to reduce the afterimage and/or the flickering. As a non-limiting example, the scan of the image A may be unnoticeable to the at least one processor 110. For example, the scan of the image A may not be recognized by the at least one processor 110 compared to the second start time recognized by the at least one processor 110.

For example, the at least one processor 110 may generate a command 202 according to the notification 201. For example, the at least one processor 110 may provide the notification 201 generated using the second program 192 to the first program 191 and generate the command 202 using the first program 191. As a non-limiting example, since the at least one processor 110 may not recognize the scan of the image A to be performed within the time interval 212 from the time 211, the at least one processor 110 may generate the command 202 according to the notification 201.

For example, the command 202 may indicate displaying an image (e.g., the image A) on the display panel 132 (e.g., a display of an image determined by the display driving circuitry 131 among the at least one processor 110 and the display driving circuitry 131). For example, the command 202 may indicate performing the repeated display of the image A on the display panel 132. For example, the command 202 may indicate the image transmission for the image B to be executed from the first start time 213. For example, the command 202 may indicate the first start time 213. For example, the command 202 may indicate performing the repeated display of the image A before the first start time 213. For example, the command 202 may include information on the first start time 213 of the image transmission for the image B and information for executing the repeated display of the image A before the first start time 213. For example, the command 202 may be referred to as a panel update command. However, it is not limited thereto.

For example, the at least one processor 110 may transmit the command 202 to the display driving circuitry 131. For example, the command 202 may be transmitted to the display driving circuitry 131 to prevent (or reduce) (or avoid) a collision between the image transmission to be executed for the display of the image B within a time interval 214 from the first start time 213 different from the second start time (or before the second start time) determined according to the frame interval and the repeated display of the image A as in the state 221 (e.g., unnoticeable to the at least one processor 110).

For example, the display driving circuitry 131 may receive the command 202 from the at least one processor 110. For example, the display driving circuitry 131 may change, according to the command 202, a start time of the frame interval from the second start time to the first start time 213. For example, the display driving circuitry 131 may process, in response to (or based on) the command 202, the repeated display of the image A as in the state 221 scheduled before the command 202 is received from the at least one processor 110. As a non-limiting example, the display driving circuitry 131 may recognize (or identify) (or check) (or detect), based on the command 202, the image transmission for the image B to be executed from the first start time 213 and change, according to the recognition, a start time of the repeated display of the image A to be performed within the time interval 212 from the time 211. For example, the display driving circuitry 131 may determine, according to the command 202, to perform the scan of the image A for the repeated display of the image A within a time interval 216 from a time 215 changed from the time 211, to complete the repeated display of the image A before the image transmission for the image B to be executed from the first start time 213.

For example, the display driving circuitry 131 may perform, by scanning the image A in the GRAM within the time interval 216 from the time 215, the repeated display of the image A on the display panel 132 as in a state 222. For example, a time interval for performing the scan of the image A for the repeated display of the image A may be moved (or changed) from the time interval 212 to the time interval 216 according to the command 202, as indicated by an arrow 231. For example, the scan of the image A within the time interval 216 for performing the repeated display of the image A as in the state 222 may be completed before the image B is received from the first start time 213 through the image transmission. For example, since the scan of the image A for the repeated display of the image A is completed before the first start time 213, the scan of the image A may also be performed from a start time of an emission period subsequent to the emission period 250 from the time 215 (e.g., an emission period having an end time of the emission period 250 from the time 215 as a start time). For example, one or more start times of the emission period 250 that may complete the scan of the image A before the first start time 213 may be used as a start time of the scan of the image A.

For example, the at least one processor 110 may transmit the image B to the display driving circuitry 131 through the interface 140 by performing the image transmission from the first start time 213. For example, the display driving circuitry 131 may receive the image B from the first start time 213, after completing, according to the command 202, the scan of the image A for the repeated display of the image A as in the state 222. For example, the display driving circuitry 131 may store the image B received from the first start time 213 in the GRAM and display the image B on the display panel 132 as in a state 223 within the time interval 214 from the first start time 213, by scanning the image B stored in the GRAM.

As described above, the command 202 transmitted from the at least one processor 110 to the display driving circuitry 131 may change scheduling of a repeated display of an image performed by the display driving circuitry 131 to reduce the afterimage and/or the flickering.

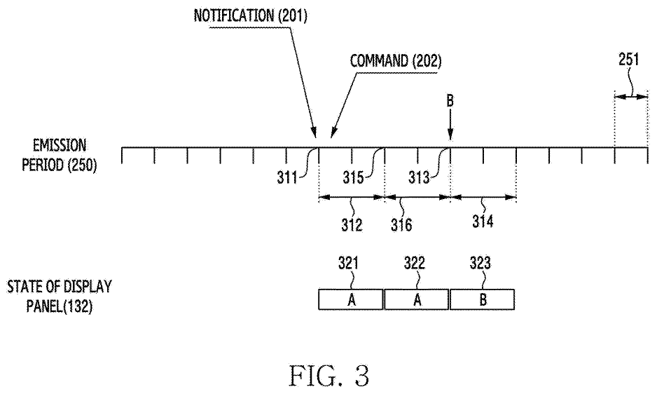

Referring to FIG. 3, the at least one processor 110 may generate a notification 201. For example, the notification 201 may be generated for an image B. For example, the notification 201 may be generated for the image B to be transmitted from the at least one processor 110 to the display driving circuitry 131, from a first start time 313 (or a first start timing 313) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before (or immediately before) performing a display of the image A or a repeated display of the image A. As a non-limiting example, the notification 201 may be generated while performing the display of the image A or the repeated display of the image A.

For example, the display driving circuitry 131 may perform the display of the image A or the repeated display of the image A as in a state 321. For example, the display driving circuitry 131 may perform a scan of the image A for the display of the image A or the repeated display of the image A, within a time interval 312 from a time 311 that may complete the display of the image A or the repeated display of the image A before the second start time determined according to the frame interval. As a non-limiting example, a length of the time interval 312 may be longer than the length 251 of the emission period 250. For example, the length of the time interval 312 may correspond to 120 (Hz). For example, the scan of the image A may be performed by reading the image A stored in the GRAM in the display driving circuitry 131. For example, the scan of the image A for the repeated display of the image A may be performed to reduce the afterimage and/or the flickering. As a non-limiting example, the scan of the image A may be unnoticeable to the at least one processor 110. For example, the scan of the image A may not be recognized by the at least one processor 110 compared to the second start time recognized by the at least one processor 110.

For example, the at least one processor 110 may generate the command 202 according to the notification 201. For example, the at least one processor 110 may provide the notification 201 generated using the second program 192 to the first program 191 and generate the command 202 using the first program 191. As a non-limiting example, since the at least one processor 110 may not recognize the scan of the image A to be performed within the time interval 312 from the time 311, the at least one processor 110 may generate the command 202 according to the notification 201.

For example, the command 202 may indicate displaying an image (e.g., the image A) on the display panel 132 (e.g., a display of an image determined by the display driving circuitry 131 among the at least one processor 110 and the display driving circuitry 131). For example, the command 202 may indicate performing the repeated display of the image A on the display panel 132. For example, the command 202 may indicate the image transmission for the image B to be executed from the first start time 313. For example, the command 202 may indicate performing the repeated display of the image A before the first start time 313. For example, the command 202 may be referred to as a panel update command. However, it is not limited thereto.

For example, the at least one processor 110 may transmit the command 202 to the display driving circuitry 131. For example, the command 202 may be transmitted to the display driving circuitry 131 to prevent (or reduce) (or avoid) a collision between the image transmission to be executed for the display of the image B within a time interval 314 from the first start time 313 different from the second start time (or before the second start time) determined according to the frame interval and the repeated display of the image A as in the state 321 (e.g., unnoticeable to the at least one processor 110).

For example, the display driving circuitry 131 may receive the command 202 from the at least one processor 110. For example, the display driving circuitry 131 may change, according to the command 202, a start time of the frame interval from the second start time to a first start time 313. For example, the command 202 may be received from the at least one processor 110 while scanning the image A in the GRAM for the display of the image A or the repeated display of the image A. For example, the display driving circuitry 131 may recognize (or identify) (or check) (or detect), based on the command 202, the image transmission for the image B to be executed from the first start time 313, and determine, according to the recognition, to perform the repeated display of the image A as in a state 322 on the display panel 132 before the first start time 313. For example, the display driving circuitry 131 may complete, according to the command 202, a scan of the image A in the GRAM for the repeated display of the image A as in the state 322 before the first start time 313. For example, the display driving circuitry 131 may perform the repeated display of the image A on the display panel 132 as in the state 322, by performing the scan of the image A in the GRAM within a time interval 316 from a time 315, according to the command 202. For example, the scan of the image A for performing the repeated display of the image A as in the state 322 within the time interval 316 may be completed before the image B is received from the first start time 313 through the image transmission.

For example, the at least one processor 110 may transmit the image B through the interface 140 to the display driving circuitry 131, by performing the image transmission from the first start time 313. For example, the display driving circuitry 131 may receive the image B from the first start time 313, after completing performing the repeated display of the image A as in the state 322 according to the command 202. For example, the display driving circuitry 131 may store the image B received from the first start time 313 in the GRAM and display the image B on the display panel 132 as in a state 323 by scanning the image B stored in the GRAM within the time interval 314 from the first start time 313.

FIG. 3 illustrates an example of performing the scan of the image A for performing the repeated display of the image A within the time interval 316, but this is merely exemplary. For example, the scan of the image A may be omitted according to a determination of the display driving circuitry 131. For example, the scan of the image A may be omitted according to a determination (e.g., the command 202) of the at least one processor 110.

As described above, the command 202 may control the display driving circuitry 131 to complete the scan of the image A in the GRAM for the repeated display of the image A before the first start time 313 for the image B that may be received from the first start time 313.

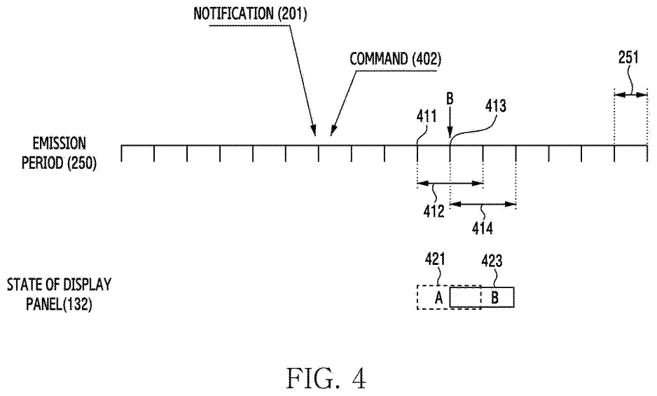

Referring to FIG. 4, the at least one processor 110 may generate a notification 201. For example, the notification 201 may be generated for an image B. For example, the notification 201 may be generated for the image B to be transmitted from the at least one processor 110 to the display driving circuitry 131 from a first start time 413 (or a first start timing 413) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 may schedule a repeated display of the image A, as in a state 421. For example, the display driving circuitry 131 may determine (or schedule) to perform a scan of the image A for the repeated display of the image A within a time interval 412 from a time 411 that may complete the repeated display of the image A before the second start time determined according to the frame interval. As a non-limiting example, a length of the time interval 412 may be longer than a length 251 of an emission period 250 (e.g., corresponding to 240 hertz (Hz)). For example, the length of the time interval 412 may correspond to 120 (Hz). For example, the scan of the image A may be performed within the time interval 412 by reading the image A stored in the GRAM in the display driving circuitry 131. For example, the scan of the image A may be performed to reduce the afterimage and/or the flickering. As a non-limiting example, the scan of the image A may be unnoticeable to the at least one processor 110. For example, the scan of the image A may not be recognized by the at least one processor 110 compared to the second start time recognized by the at least one processor 110.

For example, the at least one processor 110 may generate a command 402 according to the notification 201. For example, the at least one processor 110 may provide the notification 201 generated using the second program 192 to the first program 191 and generate the command 402 using the first program 191. As a non-limiting example, since the at least one processor 110 may not recognize the scan of the image A to be performed within the time interval 412 from the time 411, the at least one processor 110 may generate the command 402 according to the notification 201.

For example, the command 402 may indicate refraining from displaying an image (e.g., the image A) on the display panel 132 (e.g., a display of an image determined by the display driving circuitry 131 among the at least one processor 110 and the display driving circuitry 131). For example, the command 402 may indicate refraining from the repeated display of the image A on the display panel 132. For example, the command 402 may indicate the image transmission for the image B to be executed from the first start time 413. For example, the command 402 may indicate refraining from the repeated display of the image A before the first start time 413. For example, the command 402 may be referred to as a self refresh skip command. However, it is not limited thereto.

For example, the at least one processor 110 may transmit the command 402 to the display driving circuitry 131. For example, the command 402 may be transmitted to the display driving circuitry 131 to prevent (or reduce) (or avoid) a collision between the image transmission to be executed for the display of the image B within a time interval 414 from the first start time 413 different from the second start time (or before the second start time) determined according to the frame interval and the repeated display of the image A as in the state 421 (e.g., unnoticeable to the at least one processor 110).

For example, the display driving circuitry 131 may receive the command 402 from the at least one processor 110. For example, the display driving circuitry 131 may change, according to the command 402, a start time of the frame interval from the second start time to the first start time 413. For example, the display driving circuitry 131 may process, in response to (or based on) the command 402, the repeated display of the image A as in the state 421 scheduled before the command 402 is received from the at least one processor 110. As a non-limiting example, the display driving circuitry 131 may recognize (or identify) (or check) (or detect), based on the command 402, the image transmission for the image B to be executed from the first start time 413 and cancel (or skip), according to the recognition, the repeated display of the image A to be performed within the time interval 412 from the time 411. For example, the display driving circuitry 131 may cancel (or skip), according to the command 402, scanning, from the time 411, the image A in the GRAM for the repeated display of the image A to refrain from the repeated display of the image A before the image transmission for the image B to be executed from the first start time 413.

For example, the at least one processor 110 may transmit the image B through the interface 140 to the display driving circuitry 131, by performing the image transmission from the first start time 413. For example, the display driving circuitry 131 may receive the image B from the first start time 413, after canceling the repeated display of the image A allocated to the time interval 412 according to the command 402. For example, the display driving circuitry 131 may store the image B received from the first start time 413 in the GRAM and display the image B on the display panel 132 as in a state 423 within the time interval 414 from the first start time 413, by scanning the image B stored in the GRAM.

As described above, the command 402 transmitted from the at least one processor 110 to the display driving circuitry 131 may cancel (or skip) scheduling of a repeated display of an image executed by the display driving circuitry 131 to reduce the afterimage and/or the flickering.

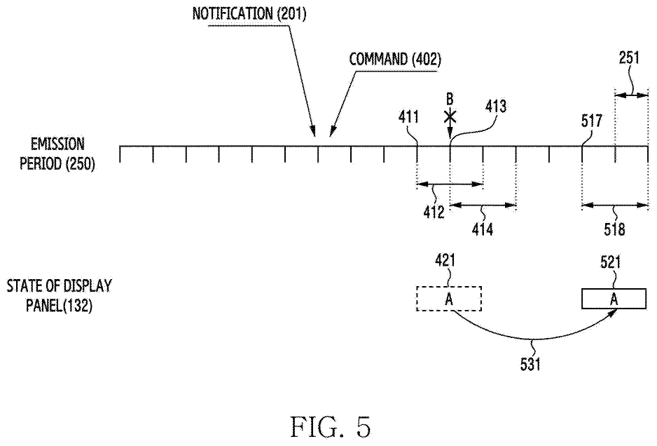

Referring to FIG. 5, the at least one processor 110 may generate a notification 201. For example, the notification 201 may be generated for an image B. For example, the notification 201 may be generated for the image B to be transmitted from the at least one processor 110 to the display driving circuitry 131 from a first start time 413 (or a first start timing 413) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 may schedule the repeated display of the image A as in the state 421. For example, the display driving circuitry 131 may determine (or schedule) to perform a scan of the image A for the repeated display of the image A within a time interval 412 from a time 411 that may complete the repeated display of the image A before the second start time determined according to the frame interval. As a non-limiting example, a length of the time interval 412 may be longer than a length 251 of an emission period 250 (e.g., corresponding to 240 hertz (Hz)). For example, the length of the time interval 412 may correspond to 120 (Hz). For example, the scan of the image A may be performed within the time interval 412 by reading the image A stored in the GRAM in the display driving circuitry 131. For example, the scan of the image A may be performed to reduce the afterimage and/or the flickering. As a non-limiting example, the scan of the image A may be unnoticeable to the at least one processor 110. For example, the scan of the image A may not be recognized by the at least one processor 110 compared to the second start time recognized by the at least one processor 110.

For example, the at least one processor 110 may generate a command 402 according to the notification 201. For example, the at least one processor 110 may provide the notification 201 generated using the second program 192 to the first program 191 and generate the command 402 using the first program 191. As a non-limiting example, since the at least one processor 110 may not recognize the scan of the image A to be performed within the time interval 412 from the time 411, the at least one processor 110 may generate the command 402 according to the notification 201.

For example, the command 402 may indicate refraining from displaying an image (e.g., the image A) on the display panel 132 (e.g., a display of an image determined by the display driving circuitry 131 among the at least one processor 110 and the display driving circuitry 131). For example, the command 402 may indicate refraining from the repeated display of the image A on the display panel 132. For example, the command 402 may indicate the image transmission for the image B to be executed from the first start time 413. For example, the command 402 may indicate refraining from the repeated display of the image A before the first start time 413. For example, the command 402 may be referred to as a self refresh skip command. However, it is not limited thereto.

For example, the at least one processor 110 may transmit the command 402 to the display driving circuitry 131. For example, the command 402 may be transmitted to the display driving circuitry 131 to prevent (or reduce) (or avoid) a collision between the image transmission to be executed for the display of the image B within a time interval 414 from the first start time 413 different from the second start time (or before the second start time) determined according to the frame interval and the repeated display of the image A as in the state 421 (e.g., unnoticeable to the at least one processor 110).

For example, the display driving circuitry 131 may receive the command 402 from the at least one processor 110. For example, the display driving circuitry 131 may change, according to the command 402, a start time of the frame interval from the second start time to the first start time 413. For example, the display driving circuitry 131 may process, in response to (or based on) the command 402, the repeated display of the image A as in the state 421 scheduled before the command 402 is received from the at least one processor 110. As a non-limiting example, the display driving circuitry 131 may recognize (or identify) (or check) (or detect), based on the command 402, the image transmission for the image B to be executed from the first start time 413 and cancel (or skip), according to the recognition, the repeated display of the image A to be performed within the time interval 412 from the time 411. For example, the display driving circuitry 131 may cancel (or skip), according to the command 402, scanning, from the time 411, the image A in the GRAM for the repeated display of the image A to refrain from the repeated display of the image A before the image transmission for the image B to be executed from the first start time 413.

For example, the at least one processor 110 may not execute the image transmission for the image B from the first start time 413 despite generating the notification 201 and the command 402. For example, the image transmission for the image B may be canceled after generating the notification 201 and the command 402 and transmitting the command 402 to the display driving circuitry 131.

For example, the display driving circuitry 131 may perform, based on the image transmission for the image B not executed from the first start time 413, the repeated display of the image A on the display panel 132 as in a state 521, by scanning the image A in the GRAM within a time interval 518 from a time 517. For example, a time interval for scanning the image A in the GRAM may be changed (or moved) from the time interval 412 to the time interval 518, as indicated by an arrow 531. For example, the scan of the image A performed within the time interval 518 may be determined by the display driving circuitry 131 based on the image transmission for the image B not executed from the first start time 413. For example, the scan of the image A within the time interval 518 may be performed according to a timeout for the image transmission for the image B. For example, the scan of the image A performed within the time interval 518 may also be executed according to a command (not illustrated) transmitted from the at least one processor 110 to the display driving circuitry 131 based on the image transmission for the image B not executed from the first start time 413. For example, a start time (e.g., the time 517) of the scan of the image A for the repeated display of the image A may be determined, based on a time during which the image A is maintained on the display panel 132, by the command 402 or the display driving circuitry 131. For example, a start time (e.g., the time 517) of the scan of the image A may be determined based on a start time of a frame interval. However, it is not limited thereto.

As described above, the command 402 transmitted from the at least one processor 110 to the display driving circuitry 131 may cancel (or skip) scheduling of a repeated display of an image performed by the display driving circuitry 131 to reduce the afterimage and/or the flickering. For example, the command 402 may control (or cause) the display driving circuitry 131 to resume the canceled repeated display, on a condition that the image transmission causing the cancelation (e.g., the image transmission for the image B) is not executed (or canceled).

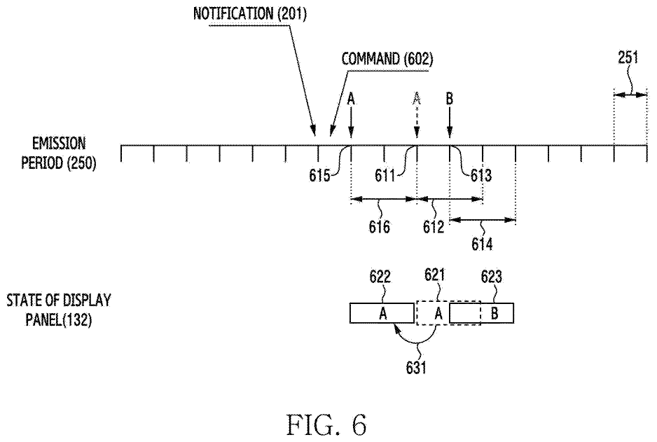

As a non-limiting example, controlling the display driving circuitry 131 through the command may be executed for an image transmission according to the second mode. This operation is exemplified in a description of FIG. 6.

FIG. 6 illustrates a method for processing a repeated display of a first image according to a notification for a second image based on a second mode according to an embodiment of the disclosure.

Referring to FIG. 6, the at least one processor 110 may generate a notification 201. For example, the notification 201 may be generated for an image B. For example, the notification 201 may be generated for the image B to be transmitted from the at least one processor 110 to the display driving circuitry 131 from a first start time 613 (or a first start timing 613) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the second mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the at least one processor 110 (or the DPU 112) may schedule a repeated display of the image A as in a state 621. For example, the at least one processor 110 (or the DPU 112) may determine (or schedule) to transmit the image A in the memory 120 to the display driving circuitry 131 for the repeated display of the image A within a time interval 612 from a time 611 that may complete the repeated display of the image A before the second start time determined according to the frame interval, according to the second mode. As a non-limiting example, a length of the time interval 612 may be longer than a length 251 of an emission period 250 (e.g., corresponding to 240 hertz (Hz)). For example, the transmission of the image A may be performed by the DPU 112. For example, the transmission of the image A may be performed to reduce the afterimage and/or the flickering. As a non-limiting example, the transmission of the image A may be unnoticeable to the CPU 111 among the CPU 111 and the DPU 112. For example, the transmission of the image A may not be recognized by the CPU 111 compared to the second start time recognized by the CPU 111.

For example, the at least one processor 110 (or the CPU 111) may generate a command 602 according to the notification 201. For example, the at least one processor 110 (or the CPU 111) may provide the notification 201 generated using the second program 192 to the first program 191 and generate the command 602 using the first program 191. As a non-limiting example, since the CPU 111 may not recognize the scan of the image A to be performed within the time interval 612 from the time 611, the CPU 111 may generate the command 602 according to the notification 201.

For example, the command 602 may indicate a display of an image (e.g., the image A) on the display panel 132 (e.g., a display of an image determined by the DPU 112 among the CPU 111 and the DPU 112). For example, the command 602 may indicate performing the repeated display of the image A on the display panel 132. For example, the command 602 may indicate the image transmission for the image B to be executed from the first start time 613. For example, the command 602 may indicate performing the repeated display of the image A before the first start time 613. For example, the command 602 may be referred to as a panel update commit. However, it is not limited thereto.

For example, the CPU 111 may transmit the command 602 to the DPU 112. For example, the command 602 may be transmitted to the DPU 112 using the first program 191. For example, the command 602 may be transmitted to the DPU 112 to prevent (or reduce) (or avoid) a collision between the image transmission to be executed for the display of the image B within a time interval 614 from the first start time 613 different from the second start time (or before the second start time) determined according to the frame interval and the repeated display of the image A as in the state 621 (e.g., unnoticeable to the CPU 111).

For example, the DPU 112 may receive the command 602 from the CPU 111. For example, the DPU 112 may change, according to the command 602, a start time of the frame interval from the second start time to the first start time 613. For example, the DPU 112 may process, in response to (or based on) the command 602, the repeated display of the image A as in the state 621 scheduled before the command 602 is received from the CPU 111. As a non-limiting example, the DPU 112 may recognize (or identify) (or check) (or detect), based on the command 602, the image transmission for the image B to be executed from the first start time 613 and change, according to the recognition, a start time of a transmission of the image A to be performed within the time interval 612 from the time 611 (e.g., an image transmission for the repeated display of the image A). For example, the DPU 112 may determine to perform the transmission of the image A for the repeated display of the image A (e.g., the image transmission to the display driving circuitry 131 executed through the interface 140 according to the second mode) within a time interval 616 from a time 615 changed from the time 611, to complete the repeated display of the image A before the image transmission for the image B to be executed from the first start time 613, according to the command 602.

For example, the DPU 112 may transmit the image A in the memory 120 to the display driving circuitry 131 within the time interval 616 from the time 615. For example, the display driving circuitry 131 may perform the repeated display of the image A on the display panel 132 as in a state 622, by scanning the image A received from the DPU 112 within the time interval 616 from the time 615. For example, a time interval for performing the scan of the image A for the repeated display of the image A may be moved (or changed) from the time interval 612 to the time interval 616, as indicated by an arrow 631, according to the command 602. For example, the scan of the image A within the time interval 616 for performing the repeated display of the image A as in the state 622 may be completed before the image B is received from the first start time 613 through the image transmission.

For example, the at least one processor 110 may transmit the image B to the display driving circuitry 131, by performing the image transmission (e.g., an image transmission from the DPU 112 to the display driving circuitry 131 executed through the interface 140) from the first start time 613. For example, the display driving circuitry 131 may receive the image B from the first start time 613 after completing the scan of the image A for the repeated display of the image A as in the state 622 according to the command 602. For example, the display driving circuitry 131 may display the image B on the display panel 132 as in a state 623 within the time interval 614 from the first start time 613, by scanning the image B received from the first start time 613.

As described above, the command 602 transmitted from the CPU 111 to the DPU 112 may change scheduling of a repeated display of an image performed to reduce the afterimage and/or the flickering.

Operations of the at least one processor 110 and the display driving circuitry 131 performed for the second mode according to the notification (e.g., the notification 201) are not limited to the description of FIG. 6. For example, operations exemplified through the descriptions of FIGS. 3 to 5 may be performed in the electronic device 100 according to the second mode. For example, when the image transmission is executed according to the second mode, at least a portion of operations of the display driving circuitry 131 exemplified through the descriptions of FIGS. 3 to 5 may be replaced with operations of the DPU 112.

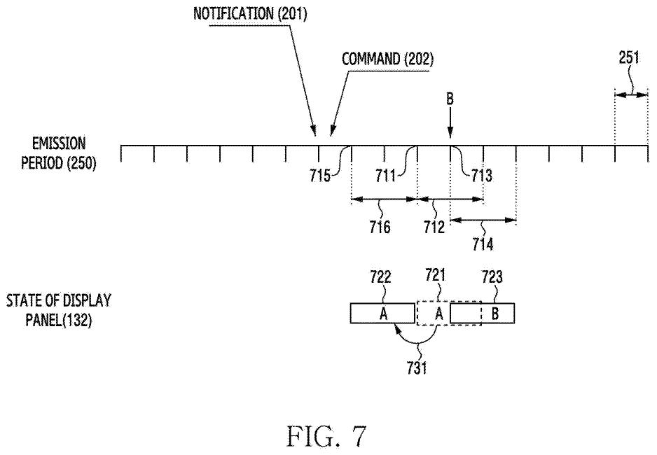

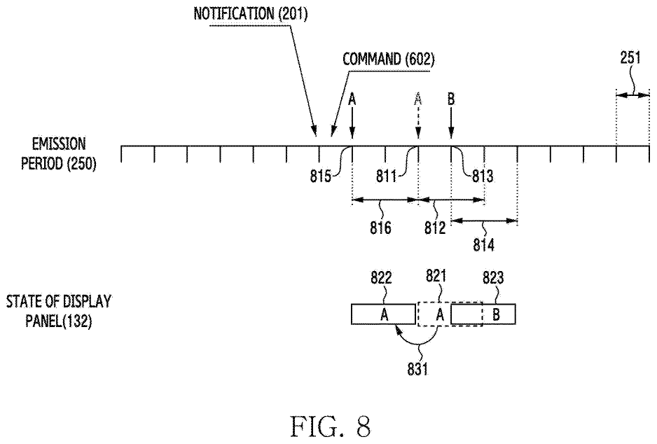

As a non-limiting example, controlling the display driving circuitry 131 through the command may be executed for an image transmission according to the third mode. This operation is exemplified in descriptions of FIGS. 7 and 8.

FIGS. 7 and 8 illustrate a method for processing a repeated display of a first image according to a notification for a second image based on a third mode according to various embodiments of the disclosure.

Referring to FIG. 7, the at least one processor 110 may generate a notification 201 while the GRAM in the display driving circuitry 131 is enabled according to the third mode. For example, the notification 201 may be generated for an image B. For example, the notification 201 may be generated for the image B to be transmitted from the at least one processor 110 to the display driving circuitry 131 from a first start time 713 (or a first start timing 713) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the third mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 may schedule a repeated display of the image A as in a state 721. For example, the display driving circuitry 131 may determine (or schedule) to perform a scan of the image A for the repeated display of the image A within a time interval 712 from a time 711 that may complete the repeated display of the image A before the second start time determined according to the frame interval. As a non-limiting example, a length of the time interval 712 may be longer than a length 251 of an emission period 250 (e.g., corresponding to 240 hertz (Hz)). For example, the length of the time interval 712 may correspond to 120 (Hz). For example, the scan of the image A may be performed by reading the image A stored in the GRAM in the display driving circuitry 131 enabled according to the third mode. For example, the scan of the image A may be performed to reduce the afterimage and/or the flickering. As a non-limiting example, the scan of the image A may be unnoticeable to the at least one processor 110. For example, the scan of the image A may not be recognized by the at least one processor 110 compared to the second start time recognized by the at least one processor 110.

For example, the at least one processor 110 may generate a command 202 according to the notification 201. For example, the command 202 may be generated while enabling the GRAM according to the third mode. For example, the at least one processor 110 may provide the notification 201 generated using the second program 192 to the first program 191 and generate the command 202 using the first program 191. As a non-limiting example, since the at least one processor 110 may not recognize the scan of the image A to be performed within the time interval 712 from the time 711, the at least one processor 110 may generate the command 202 according to the notification 201.

For example, the command 202 may indicate displaying an image (e.g., the image A) on the display panel 132 (e.g., a display of an image determined by the display driving circuitry 131 among the at least one processor 110 and the display driving circuitry 131). For example, the command 202 may indicate performing the repeated display of the image A on the display panel 132. For example, the command 202 may indicate the image transmission for the image B to be executed from the first start time 713. For example, the command 202 may indicate performing the repeated display of the image A before the first start time 713. For example, the command 202 may be referred to as a panel update command. However, it is not limited thereto.

For example, the at least one processor 110 may transmit the command 202 to the display driving circuitry 131. For example, the command 202 may be transmitted to the display driving circuitry 131 to prevent (or reduce) (or avoid) a collision between the image transmission to be executed for the display of the image B within a time interval 714 from the first start time 713 different from the second start time (or before the second start time) determined according to the frame interval and the repeated display of the image A as in a state 721 (e.g., unnoticeable to the at least one processor 110).

For example, the display driving circuitry 131 may receive the command 202 from the at least one processor 110. For example, the display driving circuitry 131 may change, according to the command 202, a start time of the frame interval from the second start time to the first start time 713. For example, the display driving circuitry 131 may process, in response to (or based on) the command 202, the repeated display of the image A as in the state 721 scheduled before the command 202 is received from the at least one processor 110. As a non-limiting example, the display driving circuitry 131 may recognize (or identify) (or check) (or detect), based on the command 202, the image transmission for the image B to be executed from the first start time 713, and change, according to the recognition, a start time of the repeated display of the image A to be performed within the time interval 712 from the time 711. For example, the display driving circuitry 131 may determine, according to the command 202, to perform the scan of the image A for the repeated display of the image A within a time interval 716 from a time 715 changed from the time 711, to complete the repeated display of the image A before the image transmission for the image B to be executed from the first start time 713.

For example, the display driving circuitry 131 may perform the repeated display of the image A on the display panel 132 as in a state 722, by scanning the image A in the GRAM enabled according to the third mode within the time interval 716 from the time 715. For example, a time interval for performing the scan of the image A for the repeated display of the image A may be moved (or changed) from the time interval 712 to the time interval 716 as indicated by an arrow 731 according to the command 202. For example, the scan of the image A within the time interval 716 for performing the repeated display of the image A as in the state 722 may be completed before the image B is received from the first start time 713 through the image transmission.

For example, the at least one processor 110 may transmit the image B through the interface 140 to the display driving circuitry 131, by performing the image transmission from the first start time 713. For example, the display driving circuitry 131 may receive the image B from the first start time 713, after completing the scan of the image A for the repeated display of the image A as in the state 722 according to the command 202. For example, the display driving circuitry 131 may display the image B on the display panel 132 as in a state 723, within the time interval 714 from the first start time 713, by scanning the image B received from the first start time 713. For example, the display driving circuitry 131 may store the image B received from the first start time 713 in the GRAM enabled according to the third mode. As a non-limiting example, the command 202 may further indicate a request to store the image B in the GRAM.

As described above, the command 202 transmitted from the at least one processor 110 to the display driving circuitry 131 may change scheduling of a repeated display of an image performed by the display driving circuitry 131 according to the third mode to reduce the afterimage and/or the flickering.

Referring to FIG. 8, the at least one processor 110 may generate the notification 201 while the GRAM in the display driving circuitry 131 is disabled according to the third mode. For example, the notification 201 may be generated for the image B. For example, the notification 201 may be generated for the image B to be transmitted from the at least one processor 110 to the display driving circuitry 131 from a first start time 813 (or a first start timing 813) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the third mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the at least one processor 110 (or the DPU 112) may schedule a repeated display of the image A as in a state 821. For example, the at least one processor 110 (or the DPU 112) may determine (or schedule) to transmit the image A in the memory 120 to the display driving circuitry 131 for the repeated display of the image A within a time interval 812 from a time 811 that may complete the repeated display of the image A before the second start time determined according to the frame interval, according to the second mode. As a non-limiting example, a length of the time interval 812 may be longer than a length 251 of an emission period 250 (e.g., corresponding to 240 hertz (Hz)). For example, the transmission of the image A may be performed by the DPU 112. For example, the transmission of the image A may be performed to reduce the afterimage and/or the flickering. As a non-limiting example, the transmission of the image A may be unnoticeable to the CPU 111 among the CPU 111 and the DPU 112. For example, the transmission of the image A may not be recognized by the CPU 111 compared to the second start time recognized by the CPU 111.

For example, the at least one processor 110 (or the CPU 111) may generate a command 602 according to the notification 201. For example, the at least one processor 110 (or the CPU 111) may provide the notification 201 generated using the second program 192 to the first program 191 and may generate the command 602 using the first program 191. As a non-limiting example, since the CPU 111 may not recognize the scan of the image A to be performed within the time interval 812 from the time 811, the CPU 111 may generate the command 602 according to the notification 201.

For example, the command 602 may indicate displaying an image (e.g., the image A) on the display panel 132 (e.g., a display of an image determined by the DPU 112 among the CPU 111 and the DPU 112). For example, the command 602 may indicate performing the repeated display of the image A on the display panel 132. For example, the command 602 may indicate the image transmission for the image B to be executed from the first start time 813. For example, the command 602 may indicate performing the repeated display of the image A before the first start time 813. For example, the command 602 may be referred to as a panel update commit. However, it is not limited thereto.

For example, the CPU 111 may transmit the command 602 to the DPU 112. For example, the command 602 may be transmitted to the DPU 112 using the first program 191. For example, the command 602 may be transmitted to the DPU 112 to prevent (or reduce) (or avoid) a collision between the image transmission to be executed for the display of the image B within a time interval 814 from the first start time 813 different from the second start time (or before the second start time) determined according to the frame interval and the repeated display of the image A as in the state 821 (e.g., unnoticeable to the CPU 111).

For example, the DPU 112 may receive the command 602 from the CPU 111. For example, the DPU 112 may change, according to the command 602, a start time of the frame interval from the second start time to the first start time 813. For example, the DPU 112 may process, in response to (or based on) the command 602, the repeated display of the image A as in the state 821 scheduled before the command 602 is received from the CPU 111. As a non-limiting example, the DPU 112 may recognize (or identify) (or check) (or detect), based on the command 602, the image transmission for the image B to be executed from the first start time 813 and change, according to the recognition, a start time of a transmission of the image A to be performed within the time interval 812 from the time 811 (e.g., an image transmission for the repeated display of the image A). For example, the DPU 112 may determine, according to the command 602, to perform the transmission of the image A for the repeated display of the image A (e.g., the image transmission to the display driving circuitry 131 executed through the interface 140 according to the third mode) within a time interval 816 from a time 815 changed from the time 811 to complete the repeated display of the image A before the image transmission for the image B to be executed from the first start time 813.

For example, the DPU 112 may transmit the image A in the memory 120 to the display driving circuitry 131 within the time interval 816 from the time 815. For example, the display driving circuitry 131 may perform the repeated display of the image A on the display panel 132 as in a state 822, by scanning the image A received from the DPU 112 within the time interval 816 from the time 815. For example, a time interval for performing the scan of the image A for the repeated display of the image A may be moved (or changed) from the time interval 812 to the time interval 816, as indicated by an arrow 831 according to the command 602. For example, the scan of the image A within the time interval 816 for performing the repeated display of the image A as in the state 822 may be completed before the image B is received from the first start time 813 through the image transmission.

For example, the at least one processor 110 may transmit the image B to the display driving circuitry 131, by performing the image transmission (e.g., an image transmission from the DPU 112 to the display driving circuitry 131 executed through the interface 140) from the first start time 813. For example, the display driving circuitry 131 may receive the image B from the first start time 813 after completing the scan of the image A for the repeated display of the image A as in the state 822 according to the command 602. For example, the display driving circuitry 131 may display the image B on the display panel 132 as in a state 823 within the time interval 814 from the first start time 813, by scanning the image B received from the first start time 813.

As described above, the command 602 transmitted from the CPU 111 to the DPU 112 may change scheduling of a repeated display of an image performed to reduce the afterimage and/or the flickering.

Operations of the at least one processor 110 and the display driving circuitry 131 performed for the third mode according to the notification (e.g., the notification 201) are not limited to the descriptions of FIGS. 7 and 8. For example, the operations exemplified through the descriptions of FIGS. 3 to 5 may be performed in the electronic device 100 according to the third mode. For example, when an image transmission is executed while enabling the GRAM according to the third mode, the display driving circuitry 131 may perform operations of the display driving circuitry 131 exemplified through the descriptions of FIGS. 3 to 5. For example, when an image transmission is executed while disabling the GRAM according to the third mode, at least a portion of operations of the display driving circuitry 131 exemplified through the descriptions of FIGS. 3 to 5 may be replaced with operations of the DPU 112.

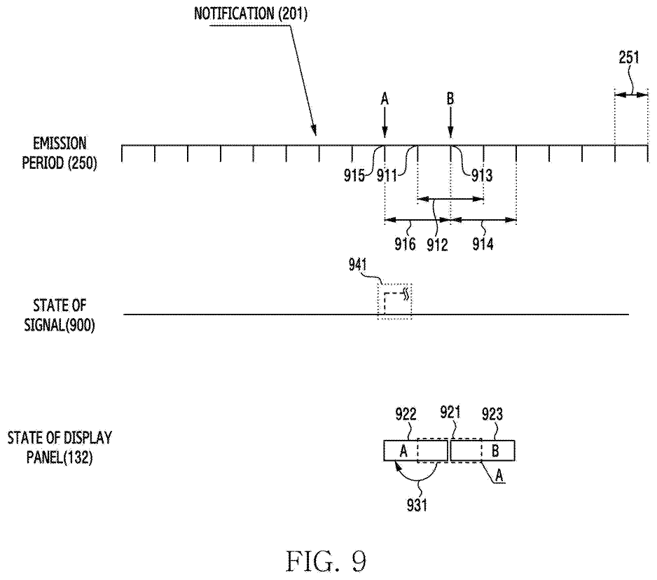

As a non-limiting example, controlling the display driving circuitry 131 based on generating the notification may be executed for an image transmission according to the fourth mode. This operation is exemplified in descriptions of FIGS. 9 to 13.

FIGS. 9 to 13 illustrate a method for processing a repeated display of a first image according to a notification for a second image based on a fourth mode according to various embodiments of the disclosure.

Referring to FIG. 9, the at least one processor 110 may generate the notification 201. For example, the notification 201 may be generated for the image B. For example, the notification 201 may be generated for the image B to be transmitted from the at least one processor 110 to the display driving circuitry 131 from a first start time 913 (or a first start timing 913) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the fourth mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 (and/or the at least one processor 110) may schedule the repeated display of the image A as in a state 921. For example, the display driving circuitry 131 may determine (or schedule) to request, to the at least one processor 110, a transmission of an image (e.g., the image A) to perform the repeated display of the image (e.g., the image A) within a time interval 912 from a time 911 that may complete the repeated display of the image A before the second start time determined according to the frame interval. For example, the determination may be executed according to control of the at least one processor 110. As a non-limiting example, a length of the time interval 912 may be longer than a length 251 of an emission period 250 (e.g., corresponding to 240 hertz (Hz)). For example, the length of the time interval 912 may correspond to 120 (Hz). For example, the display driving circuitry 131 may request the image (e.g., the image A) to the at least one processor 110 by changing a state of a signal 900 from a first state to a second state from a time 915, as in a state 941. For example, the signal 900 may be transmitted from the display driving circuitry 131 to the processor 110 to request a transmission of an image to the at least one processor 110. For example, the signal 900 may be defined for the fourth mode. For example, the request may be performed to reduce the afterimage and/or the flickering. As a non-limiting example, the request may be recognized by the at least one processor 110 before changing the state of the signal 900 from the first state to the second state as in the state 941.

For example, the at least one processor 110 may change (or move), according to (or based on) the notification 201, a time interval for performing the repeated display of the image A from the time interval 912 to a time interval 916. For example, the at least one processor 110 may change (or move), according to the image transmission for the image B to be executed from the first start time 913 (or the notification 201), the time interval for performing the repeated display of the image A from the time interval 912 to the time interval 916. For example, the at least one processor 110 may transmit the image A to the display driving circuitry 131 by executing an image transmission to the display driving circuitry 131 from the time 915 (e.g., the image transmission from the at least one processor 110 to the display driving circuitry 131 executed through the interface 140), before the state of the signal 900 is changed from the first state to the second state by the display driving circuitry 131 as in the state 941. For example, the display driving circuitry 131 may perform the repeated display of the image A on the display panel 132 as in a state 922, by scanning the image A received within the time interval 916 from the time 915. For example, the at least one processor 110 may change (or move), according to the notification 201, a time interval for performing the repeated display of the image A from the time interval 912 to the time interval 916, as indicated by an arrow 931. The change of the time interval indicated by the arrow 931 may be executed to prevent (or reduce) (or avoid) a collision between the image transmission to be executed for the display of the image B within a time interval 914 from the first start time 913 different from the second start time (or before the second start time) determined according to the frame interval and the repeated display of the image A as in the state 921.

For example, the at least one processor 110 may transmit the image B to the display driving circuitry 131 through the interface 140, by performing the image transmission from the first start time 913. For example, the display driving circuitry 131 may display the image B on the display panel 132 as in a state 923, by scanning the image B received from the first start time 913 within the time interval 914 from the first start time 913.

As described above, the notification 201 generated by the at least one processor 110 may change a time (or timing) for transmitting an image to the display driving circuitry 131 to reduce the afterimage and/or the flickering within the fourth mode.

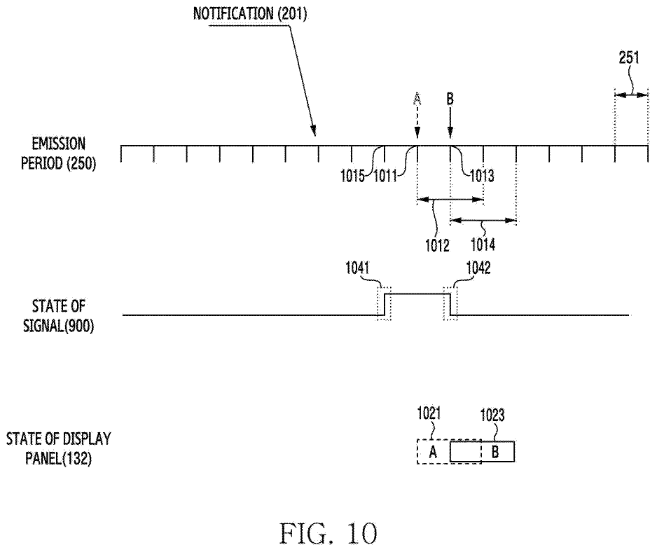

Referring to FIG. 10, the at least one processor 110 may generate a notification 201. For example, the notification 201 may be generated for an image B. For example, the notification 201 may be generated for the image B to be transmitted from the at least one processor 110 to the display driving circuitry 131 from a first start time 1013 (or a first start timing 1013) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the fourth mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 (and/or the at least one processor 110) may schedule the repeated display of the image A as in a state 1021. For example, the display driving circuitry 131 may determine (or schedule) to request, to the at least one processor 110, a transmission of an image (e.g., the image A) to perform the repeated display of the image (e.g., the image A) within a time interval 1012 from a time 1011 that may complete the repeated display of the image A before the second start time determined according to the frame interval. For example, the determination may be executed according to control of the at least one processor 110. As a non-limiting example, a length of the time interval 1012 may be longer than a length 251 of an emission period 250 (e.g., corresponding to 240 hertz (Hz)). For example, the length of the time interval 1012 may correspond to 120 (Hz). For example, the display driving circuitry 131 may request the image (e.g., the image A) to the at least one processor 110, by changing a state of the signal 900 from the first state to the second state from a time 1015, as in a state 1041. For example, the request may be performed to reduce the afterimage and/or the flickering. As a non-limiting example, the request may be recognized by the at least one processor 110 before changing the state of the signal 900 from the first state to the second state as in the state 1041.

For example, the at least one processor 110 may cancel a transmission of the image A allocated to the time interval 1012, according to (or based on) the notification 201. For example, the at least one processor 110 may cancel the transmission of the image A allocated to the time interval 1012 for an image transmission (e.g., an image transmission for the image B) to be executed within a time interval 1014 from the first start time 1013. For example, the at least one processor 110 may refrain from or skip executing the image transmission for the image A from the time 1011 for the repeated display of the image A.

As a non-limiting example, a state of the signal 900 transmitted from the display driving circuitry 131 to the at least one processor 110 may be maintained as the second state, according to canceling transmitting the image A to the display driving circuitry 131.

For example, the at least one processor 110 may transmit the image B through the interface 140 to the display driving circuitry 131, by performing the image transmission from the first start time 1013. For example, the display driving circuitry 131 may change the state of the signal 900 from the second state to the first state, as in a state 1042, in response to the image B received from the first start time 1013. For example, the display driving circuitry 131 may display the image B on the display panel 132 as in a state 1023, by scanning the image B received from the first start time 1013 within the time interval 1014 from the first start time 1013.

As described above, the notification 201 generated by the at least one processor 110 may cancel or refrain from an image transmission to the display driving circuitry 131 to be executed to reduce the afterimage and/or the flickering within the fourth mode.

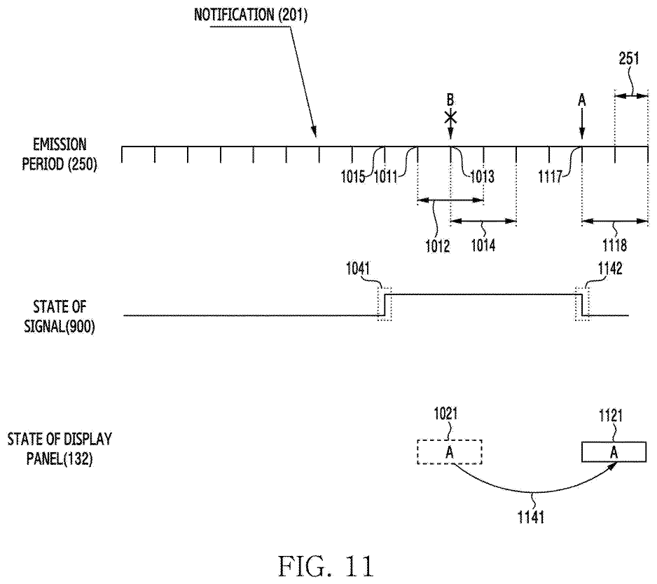

Referring to FIG. 11, the at least one processor 110 may generate a notification 201. For example, the notification 201 may be generated for an image B. For example, the notification 201 may be generated for the image B to be transmitted from the at least one processor 110 to the display driving circuitry 131 from a first start time 1013 (or a first start timing 1013) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the fourth mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 (and/or the at least one processor 110) may schedule the repeated display of the image A as in the state 1021. For example, the display driving circuitry 131 may determine (or schedule) to request, to the at least one processor 110, a transmission of an image (e.g., the image A) to perform the repeated display of the image (e.g., the image A) within a time interval 1012 from a time 1011 that may complete the repeated display of the image A before the second start time determined according to the frame interval. For example, the determination may be executed according to control of the at least one processor 110. As a non-limiting example, a length of the time interval 1012 may be longer than a length 251 of an emission period 250 (e.g., corresponding to 240 hertz (Hz)). For example, the length of the time interval 1012 may correspond to 120 (Hz). For example, the display driving circuitry 131 may request the image (e.g., the image A) to the at least one processor 110, by changing a state of the signal 900 from the first state to the second state from a time 1015 as in a state 1041. For example, the request may be performed to reduce the afterimage and/or the flickering. As a non-limiting example, the request may be recognized by the at least one processor 110 before changing the state of the signal 900 from the first state to the second state as in the state 1041.

For example, the at least one processor 110 may cancel a transmission of the image A allocated to the time interval 1012, according to (or based on) the notification 201. For example, the at least one processor 110 may cancel the transmission of the image A allocated to the time interval 1012 for an image transmission (e.g., an image transmission for the image B) to be executed within a time interval 1014 from the first start time 1013. For example, the at least one processor 110 may skip executing the image transmission for the image A from the time 1011 for the repeated display of the image A.

As a non-limiting example, a state of the signal 900 transmitted from the display driving circuitry 131 to the at least one processor 110 may be maintained as the second state according to canceling transmitting the image A to the display driving circuitry 131.

For example, the at least one processor 110 may not execute the image transmission for the image B from the first start time 1013 despite generating the notification 201. For example, the image transmission for the image B may be canceled after generating the notification 201.

For example, the at least one processor 110 may transmit the image A through the interface 140 to the display driving circuitry 131 by performing the image transmission from a time 1117 according to canceling the image transmission for the image B. For example, the image transmission for the repeated display of the image A as in a state 1121 may be executed within a time interval 1118 from the time 1117. For example, the image transmission for the repeated display of the image A as in the state 1121 may be performed according to a timeout for the image transmission for the image B. For example, the display driving circuitry 131 may change the state of the signal 900 from the second state to the first state as in a state 1142, in response to the image A received from the time 1117. For example, the display driving circuitry 131 may perform the repeated display of the image A on the display panel 132 as in the state 1121, by scanning the image A received from the time 1117 within the time interval 1118 from the time 1117. For example, a time interval for performing the repeated display of the image A may be changed (or moved) from the time interval 1012 to the time interval 1118 as indicated by an arrow 1141, based on the image transmission for the image B not executed according to the notification 201.

As described above, the notification 201 generated by the at least one processor 110 may change a time interval of the image transmission to the display driving circuitry 131 executed to reduce the afterimage and/or the flickering, within the fourth mode.

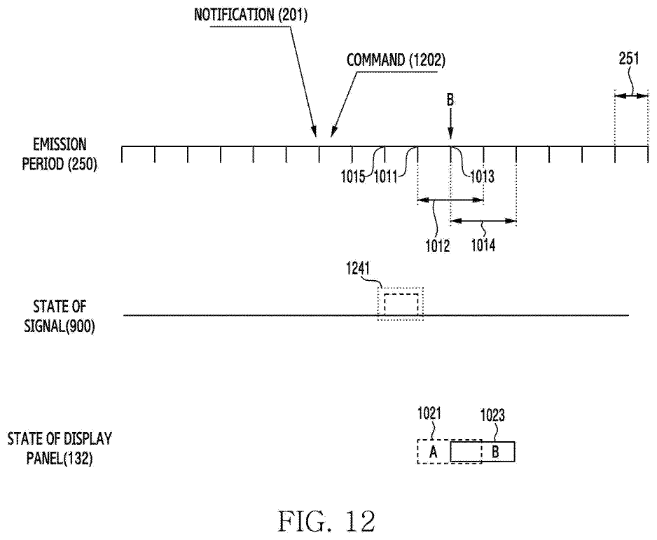

Referring to FIG. 12, the at least one processor 110 may generate a notification 201. For example, the notification 201 may be generated for an image B. For example, the notification 201 may be generated for the image B to be transmitted from the at least one processor 110 to the display driving circuitry 131 from a first start time 1013 (or a first start timing 1013) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the fourth mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 (and/or the at least one processor 110) may schedule the repeated display of the image A as in a state 1021. For example, the display driving circuitry 131 may determine (or schedule) to request, to the at least one processor 110, a transmission of an image (e.g., the image A) to perform the repeated display of the image (e.g., the image A) within a time interval 1012 from a time 1011 that may complete the repeated display of the image A before the second start time determined according to the frame interval. For example, the determination may be executed according to control of the at least one processor 110. As a non-limiting example, a length of the time interval 1012 may be longer than a length 251 of an emission period 250 (e.g., corresponding to 240 hertz (Hz)). For example, the length of the time interval 1012 may correspond to 120 (Hz). For example, the display driving circuitry 131 may request the image (e.g., the image A) to the at least one processor 110 by changing a state of the signal 900 from the first state to the second state from a time 1015. For example, the request may be performed to reduce the afterimage and/or the flickering. As a non-limiting example, the request may be recognized by the at least one processor 110 before changing the state of the signal 900 from the first state to the second state.

For example, since the at least one processor 110 may recognize the request performed through changing the state of the signal 900 from the first state to the second state, the at least one processor 110 may generate a command 1202 according to the notification 201. For example, the command 1202 may be generated to cancel a change of the state of the signal 900 (e.g., the change from the first state to the second state) to be performed from the time 1015. For example, the command 1202 may indicate maintaining the state of the signal 900 as the first state. For example, the command 1202 may be referred to as a self refresh skip command. However, it is not limited thereto.

For example, the at least one processor 110 may transmit the command 1202 to the display driving circuitry 131. For example, the command 1202 may be transmitted to the display driving circuitry 131 to maintain the state of the signal 900 as the first state. For example, the command 1202 may be transmitted to the display driving circuitry 131 to cancel the repeated display of the image A allocated to the time interval 1012.

For example, the display driving circuitry 131 may receive the command 1202 from the at least one processor 110. For example, the display driving circuitry 131 may refrain from (or cancel) changing the state of the signal 900 from the first state to the second state from the time 1015, in response to (or based on) the command 1202. For example, the display driving circuitry 131 may maintain the state of the signal 900 as the first state, as in a state 1241, in response to (or based on) the command 1202.

For example, the at least one processor 110 may transmit the image B through the interface 140 to the display driving circuitry 131, by performing the image transmission from the first start time 1013. For example, the display driving circuitry 131 may display the image B on the display panel 132 as in a state 1023, by scanning the image B received from the first start time 1013 within the time interval 1014 from the first start time 1013.

As described above, the notification 201 generated by the at least one processor 110 may generate the command 1202 for canceling the change of the state of the signal 900 transmitted from the display driving circuitry 131 to the at least one processor 110.

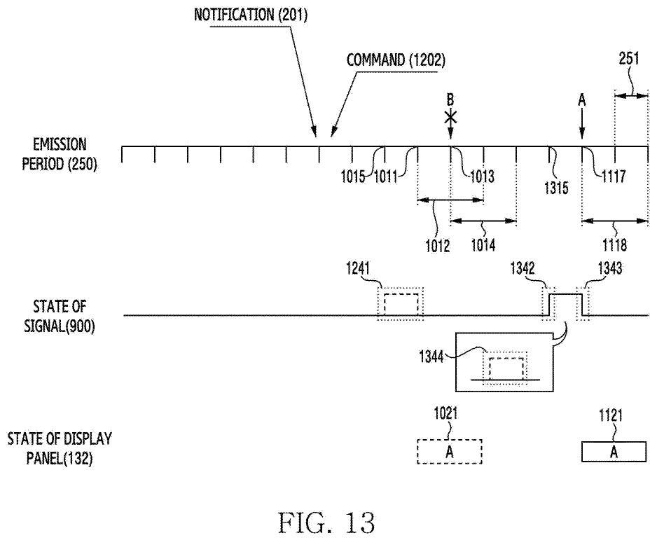

Referring to FIG. 13, the at least one processor 110 may generate a notification 201. For example, the notification 201 may be generated for an image B. For example, the notification 201 may be generated for the image B to be transmitted from the at least one processor 110 to the display driving circuitry 131 from a first start time 1013 (or a first start timing 1013) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the fourth mode). For example, the notification 201 may be generated while an image A is displayed on the display panel 132. For example, the notification 201 may be generated using the second program 192. For example, the notification 201 may be generated by the CPU 111 among the CPU 111 and the DPU 112. As a non-limiting example, the notification 201 may be generated before performing a repeated display of the image A.

For example, the display driving circuitry 131 (and/or the at least one processor 110) may schedule the repeated display of the image A as in a state 1021. For example, the display driving circuitry 131 may determine (or schedule) to request, to the at least one processor 110, a transmission of an image (e.g., the image A) to perform the repeated display of the image (e.g., the image A) within a time interval 1012 from a time 1011 that may complete the repeated display of the image A before the second start time determined according to the frame interval. For example, the determination may be executed according to control of the at least one processor 110. As a non-limiting example, a length of the time interval 1012 may be longer than a length 251 of an emission period 250 (e.g., corresponding to 240 hertz (Hz)). For example, the length of the time interval 1012 may correspond to 120 (Hz). For example, the display driving circuitry 131 may request the image (e.g., the image A) to the at least one processor 110 by changing a state of the signal 900 from the first state to the second state from a time 1015. For example, the request may be performed to reduce the afterimage and/or the flickering. As a non-limiting example, the request may be recognized by the at least one processor 110 before changing the state of the signal 900 from the first state to the second state.

For example, since the at least one processor 110 may recognize the request performed through changing the state of the signal 900 from the first state to the second state, the at least one processor 110 may generate a command 1202 according to the notification 201. For example, the command 1202 may be generated to cancel a change of the state of the signal 900 (e.g., the change from the first state to the second state) to be performed from the time 1015. For example, the command 1202 may indicate maintaining the state of the signal 900 as the first state. For example, the command 1202 may be referred to as a self refresh skip command. However, it is not limited thereto.

For example, the at least one processor 110 may transmit the command 1202 to the display driving circuitry 131. For example, the command 1202 may be transmitted to the display driving circuitry 131 to maintain the state of the signal 900 as the first state. For example, the command 1202 may be transmitted to the display driving circuitry 131 to cancel the repeated display of the image A allocated to the time interval 1012.

For example, the display driving circuitry 131 may receive the command 1202 from the at least one processor 110. For example, the display driving circuitry 131 may refrain from (or cancel) changing the state of the signal 900 from the first state to the second state from the time 1015, in response to (or based on) the command 1202. For example, the display driving circuitry 131 may maintain the state of the signal 900 as the first state, as in the state 1241, in response to (or based on) the command 1202.

For example, the at least one processor 110 may not execute the image transmission for the image B within the time interval 1014 from the first start time 1013 despite generating the notification 201. For example, the image transmission for the image B may be canceled after generating the notification 201.

For example, the at least one processor 110 may transmit the image A through the interface 140 to the display driving circuitry 131 by performing the image transmission from a time 1117 according to canceling the image transmission for the image B. For example, the image transmission for the repeated display of the image A as in a state 1121 may be executed within a time interval 1118 from the time 1117. For example, the image transmission for the repeated display of the image A as in the state 1121 may be performed according to a timeout for the image transmission for the image B.

For example, the image transmission for the repeated display of the image A as in the state 1121 may be triggered (or started) (or initiated) by the display driving circuitry 131. For example, the display driving circuitry 131 may change the state of the signal 900 from the first state to the second state from a time 1315 as in a state 1342, according to detecting (or recognizing) (or identifying) the timeout. For example, the at least one processor 110 may execute the image transmission for the repeated display of the image A as in the state 1121 from the time 1117, based on detecting (or recognizing) (or identifying) that the state of the signal 900 is changed from the first state to the second state as in the state 1342. For example, the display driving circuitry 131 may change the state of the signal 900 from the second state to the first state as in a state 1343, in response to the image A received from the time 1117. For example, the display driving circuitry 131 may perform the repeated display of the image A on the display panel 132 as in the state 1121, by scanning the image A received from the time 1117 within the time interval 1118 from the time 1117. For example, a time interval for performing the repeated display of the image A may be changed (or moved) from the time interval 1012 to the time interval 1118, based on an image transmission for the image B not executed according to the notification 201.

For example, the image transmission for the repeated display of the image A as in the state 1121 may be triggered (or started) (or initiated) by the at least one processor 110. For example, the at least one processor 110 may execute the image transmission for the repeated display of the image A as in the state 1121 from the time 1117, according to detecting (or recognizing) (or identifying) the timeout. For example, since the image transmission executed from the time 1117 is triggered by the at least one processor 110, the state of the signal 900 may be maintained as the first state as in a state 1344. For example, the display driving circuitry 131 may perform the repeated display of the image A on the display panel 132 as in the state 1121, by scanning the image A received from the time 1117 within the time interval 1118 from the time 1117. For example, a time interval for performing the repeated display of the image A may be changed (or moved) from the time interval 1012 to the time interval 1118, based on an image transmission for the image B not executed according to the notification 201.

As described above, cancelation of a display of the image B for generating the notification 201 may cause a change of a time interval for performing a repeated display of the image A. For example, the change of the time interval may be triggered by the display driving circuitry 131 or may be triggered by the at least one processor 110.

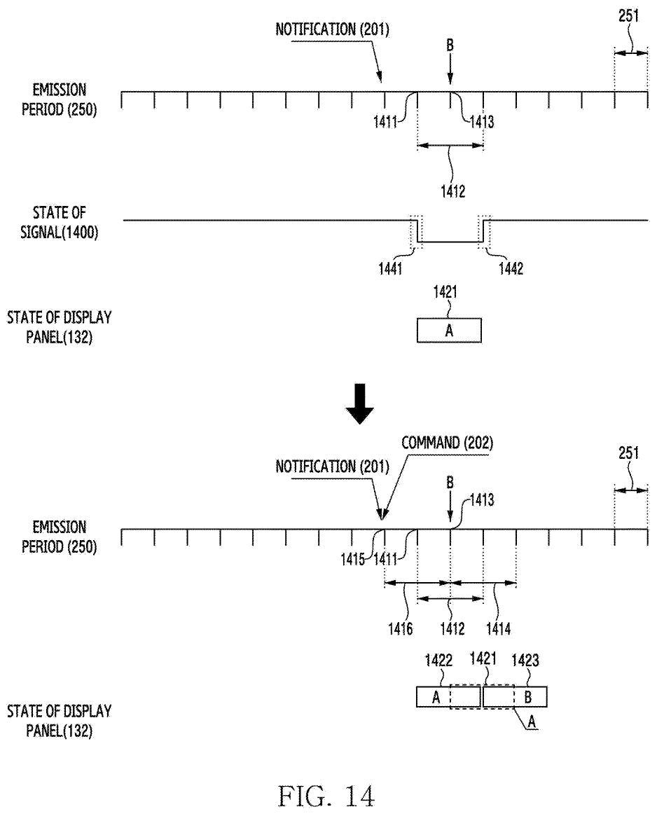

As exemplified above, the notification (e.g., the notification 201) may cause completing the repeated display of the image A before receiving the image B or refraining from the repeated display of the image A before receiving the image B. For example, a signal indicating a state of the repeated display of the image A may be defined in the electronic device 100 to determine whether to complete the repeated display of the image A before receiving the image B or to refrain from the repeated display of the image A before receiving the image B. For example, the signal may be in a first state indicating a state of the display driving circuitry 131 not performing a scan for the repeated display of the image A or a second state indicating a state of the display driving circuitry 131 performing the scan for the repeated display of the image A. The signal is exemplified in descriptions of FIGS. 14 to 16.

FIGS. 14 to 16 illustrate a method for determining whether to transmit a command to display driving circuitry according to a state of a signal from the display driving circuitry to at least one processor according to various embodiments of the disclosure.

Referring to FIG. 14, the at least one processor 110 may generate a notification 201. For example, the notification 201 may be generated for an image B. For example, the notification 201 may be generated for the image B to be transmitted from the at least one processor 110 to the display driving circuitry 131 from a first start time 1413 (or a first start timing 1413) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112.

For example, the notification 201 may be generated before a reference time interval from the first start time 1413 of the image transmission for the image B. For example, a length of the reference time interval may be equal to a time consumed for a scan of an image (e.g., a scan for a display of the image) (e.g., a length of a time interval 1412 longer than the length 251 of the emission period 250 (e.g., corresponding to 120 (Hz))). For example, the length of the reference time interval may be longer than the time consumed for the scan of the image.

For example, the display driving circuitry 131 may transmit a signal 1400 to the at least one processor 110. For example, the signal 1400 may indicate a state of a scan of an image (e.g., a scan for a display of the image (and/or for a repeated display of the image)). For example, the signal 1400 may be in the first state indicating the state of the display driving circuitry 131 not performing the scan of the image or the second state indicating a state of the display driving circuitry 131 performing the scan of the image. For example, when a scan for the repeated display of the image A is allocated to the time interval 1412 from a time 1411 before generation of the notification 201, the display driving circuitry 131 may change, in response to start of the scan, the state of the signal 1400 from the first state to the second state as in a state 1441, and change, in response to end (or completion) of the scan, the state of the signal 1400 from the second state to the first state as in a state 1442.

For example, the at least one processor 110 may identify (or monitor) the state of the signal 1400 to determine whether to generate a command according to the notification 201. For example, the at least one processor 110 may generate a command 202 (or a command 602), based on the notification 201 generated while the signal 1400 is in the first state. The command 202 may be transmitted to the display driving circuitry 131. The command 602 may be transmitted to the DPU 112.

For example, the command 202 (or the command 602) may be generated to complete the repeated display of the image A before the first start time 1413. For example, the command 202 may cause changing a time interval for performing a scan for the repeated display of the image A from the time interval 1412 to a time interval 1416. For example, the command 202 may cause canceling the repeated display of the image A as in a state 1421, and completing, before the first start time 1413, the repeated display of the image A as in a state 1422.

For example, the display driving circuitry 131 may perform the repeated display of the image A as in the state 1422, by performing a scan of the image A within a time interval 1416 from a time 1415, according to the command 202. For example, the display driving circuitry 131 may display the image B on the display panel 132 as in a state 1423, by scanning the image B received within a time interval 1414 from the first start time 1413.

As described above, the notification 201 generated while the signal 1400 is in the first state may generate the command 202 (or the command 602).

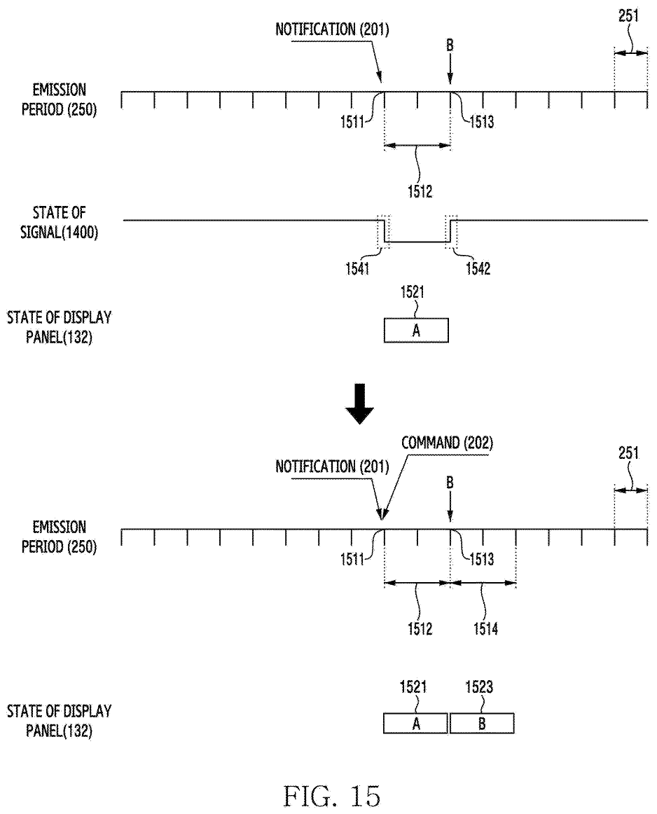

Referring to FIG. 15, the at least one processor 110 may generate a notification 201. For example, the notification 201 may be generated for an image B. For example, the notification 201 may be generated for the image B to be transmitted from the at least one processor 110 to the display driving circuitry 131 from a first start time 1513 (or a first start timing 1513) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112.

For example, the notification 201 may be generated before the reference time interval from the first start time 1513 of the image transmission for the image B. For example, a length of the reference time interval may be equal to a time consumed for a scan of an image (e.g., a scan for a display of the image) (e.g., a length of a time interval 1512 longer than the length 251 of the emission period 250 (e.g., corresponding to 120 (Hz))). For example, the length of the reference time interval may be longer than the time consumed for the scan of the image.

For example, the display driving circuitry 131 may transmit a signal 1400 to the at least one processor 110. For example, the signal 1400 may indicate a state of a scan of an image (e.g., a scan for a display of the image (and/or for a repeated display of the image)). For example, the signal 1400 may be in the first state indicating a state of the display driving circuitry 131 not performing the scan of the image or the second state indicating a state of the display driving circuitry 131 performing the scan of the image. For example, when a scan for the repeated display of the image A as in a state 1521 is allocated to the time interval 1512 from a time 1511 before generation of the notification 201, the display driving circuitry 131 may change, in response to start of the scan, the state of the signal 1400 from the first state to the second state as in a state 1541, and change, in response to end (or completion) of the scan, the state of the signal 1400 from the second state to the first state as in a state 1542.

For example, the at least one processor 110 may identify (or monitor) the state of the signal 1400 to determine whether to generate a command according to the notification 201. For example, the at least one processor 110 may generate a command 202 (or a command 602), based on the notification 201 generated while the signal 1400 is in the first state. The command 202 may be transmitted to the display driving circuitry 131. The command 602 may be transmitted to the DPU 112.

For example, the command 202 (or the command 602) may be generated to complete the repeated display of the image A before the first start time 1513.

For example, the display driving circuitry 131 may perform the repeated display of the image A as in the state 1521, by performing the scan of the image A within the time interval 1512 from the time 1511, according to the command 202. For example, the display driving circuitry 131 may display the image B on the display panel 132 as in a state 1523, by scanning the image B received within a time interval 1514 from the first start time 1513.

As described above, the notification 201 generated while the signal 1400 is in the first state may generate the command 202 (or the command 602).

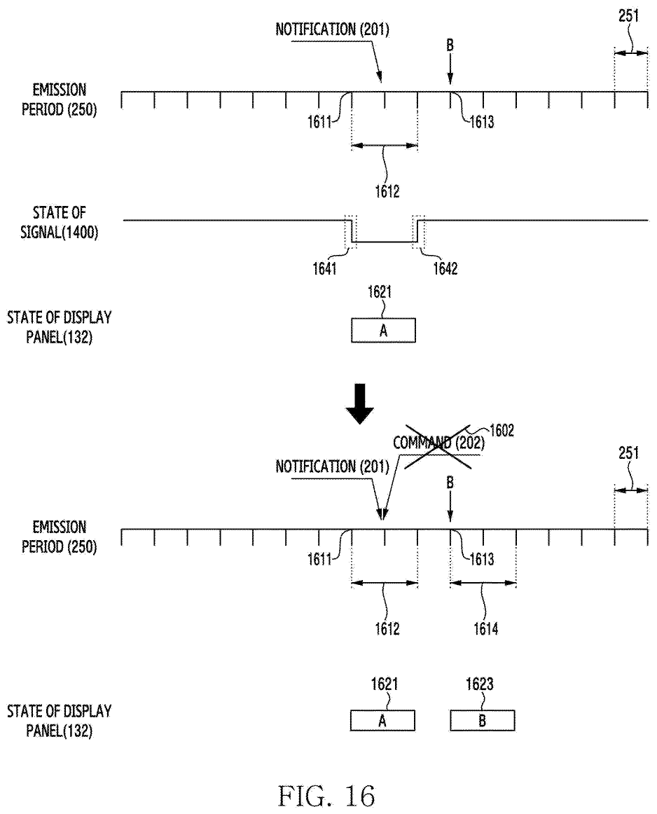

Referring to FIG. 16, the at least one processor 110 may generate a notification 201. For example, the notification 201 may be generated for an image B. For example, the notification 201 may be generated for the image B to be transmitted from the at least one processor 110 to the display driving circuitry 131 from a first start time 1613 (or a first start timing 1613) different from the second start time (or the second start timing) determined according to the frame interval. For example, the notification 201 may be generated for an image transmission for the image B (e.g., an image transmission from the at least one processor 110 (or the DPU 112) to the display driving circuitry 131 executed through the interface 140 according to the first mode). For example, the notification 201 may be generated while an image A is displayed on the display panel 132. For example, the notification 201 may be generated using the second program 192. For example, the notification 201 may be generated by the CPU 111 among the CPU 111 and the DPU 112.

For example, the notification 201 may be generated before the reference time interval from the first start time 1613 of the image transmission for the image B. For example, a length of the reference time interval may be equal to a time consumed for a scan of an image (e.g., a scan for a display of the image) (e.g., a length of a time interval 1612 longer than the length 251 of the emission period 250 (e.g., corresponding to 120 (Hz))). For example, the length of the reference time interval may be longer than the time consumed for the scan of the image.

For example, the display driving circuitry 131 may transmit a signal 1400 to the at least one processor 110. For example, the signal 1400 may indicate a state of a scan of an image (e.g., a scan for a display of the image (and/or for a repeated display of the image)). For example, the signal 1400 may be in the first state indicating a state of the display driving circuitry 131 not performing the scan of the image or the second state indicating a state of the display driving circuitry 131 performing the scan of the image. For example, when a scan for the repeated display of the image A is allocated to the time interval 1612 from a time 1611 before generation of the notification 201, the display driving circuitry 131 may change, in response to start of the scan, the state of the signal 1400 from the first state to the second state as in a state 1641, and change, in response to end (or completion) of the scan, the state of the signal 1400 from the second state to the first state as in a state 1642.

For example, the at least one processor 110 may identify (or monitor) the state of the signal 1400 to determine whether to generate a command according to the notification 201. For example, the at least one processor 110 may refrain from generating the command 202 (or the command 602) as indicated by a state 1602, based on the notification 201 generated while the signal 1400 is in the second state. For example, since the notification 201 generated while the signal 1400 is in the second state indicates that a collision occurs between a transmission of the image B to be executed from the first start time 1613 and the repeated display of the image A, the at least one processor 110 may refrain from generating the command 202 (or the command 602) as indicated by the state 1602, based on the notification 201 generated while the signal 1400 is in the second state.

For example, the display driving circuitry 131 may perform the repeated display of the image A as in a state 1621, by performing a scan of the image A within the time interval 1612 from the time 1611 including a time at which the notification 201 is generated. For example, since the command 202 (or the command 602) is not generated according to the notification 201 generated while the signal 1400 is in the second state, the display driving circuitry 131 may not perform an additional scan for the repeated display of the image A after performing the scan of the image A within the time interval 1612. For example, the display driving circuitry 131 may display the image B on the display panel 132 as in a state 1623, by scanning the image B received within a time interval 1614 from the first start time 1613.

As described above, the notification 201 generated while the signal 1400 is in the second state may refrain from or block generating the command 202 (or the command 602).

For example, the at least one processor 110 may cause completing the repeated display of the image A before receiving the image B or refraining from the repeated display of the image A before receiving the image B, according to a time (or a timing) at which the notification (e.g., the notification 201) is generated. For example, a type of a command generated by the at least one processor 110 may vary according to the time at which the notification is generated.

For example, the at least one processor 110 may generate the notification for an image transmission to the display driving circuitry 131 to be executed from the first start time different from the second start time that is determined according to a frame interval, while the first image is displayed on the display panel 132. For example, the at least one processor 110 may generate a first command based on the notification generated outside a reference time interval from the first start time and control the display driving circuitry 131 to complete the repeated display of the first image on the display panel 132, before data for a second image is transmitted to the display driving circuitry 131 through the image transmission executed from the first start time, according to the first command. For example, the at least one processor 110 may generate a second command based on the notification generated within the reference time interval from the first start time and control the display driving circuitry 131 to refrain from performing the repeated display of the first image on the display panel 132, before the data for the second image is transmitted to the display driving circuitry 131 through the image transmission executed from the first start time, according to the second command.

The notification (e.g., the notification 201) exemplified above may be further used to determine (or predict) a state of the display 130. For example, the display 130 may identify (or recognize) a time interval in which a display of an image is not performed based on the notification. For example, the display 130 may operate in a state for lower power consumption, within the time interval.

The operations exemplified above may be executed by an electronic device 1701 exemplified in descriptions of FIGS. 17 and 18 below.

FIG. 17 is a block diagram illustrating an electronic device 1701 in a network environment 1700 according to an embodiment of the disclosure.

Referring to FIG. 17, the electronic device 1701 in the network environment 1700 may communicate with an electronic device 1702 via a first network 1798 (e.g., a short-range wireless communication network), or at least one of an electronic device 1704 or a server 1708 via a second network 1799 (e.g., a long-range wireless communication network). According to an embodiment, the electronic device 1701 may communicate with the electronic device 1704 via the server 1708. According to an embodiment, the electronic device 1701 may include a processor 1720, memory 1730, an input module 1750, a sound output module 1755, a display module 1760, an audio module 1770, a sensor module 1776, an interface 1777, a connecting terminal 1778, a haptic module 1779, a camera module 1780, a power management module 1788, a battery 1789, a communication module 1790, a subscriber identification module (SIM) 1796, or an antenna module 1797. In some embodiments, at least one of the components (e.g., the connecting terminal 1778) may be omitted from the electronic device 1701, or one or more other components may be added in the electronic device 1701. In some embodiments, some of the components (e.g., the sensor module 1776, the camera module 1780, or the antenna module 1797) may be implemented as a single component (e.g., the display module 1760).

The processor 1720 may execute, for example, software (e.g., a program 1740) to control at least one other component (e.g., a hardware or software component) of the electronic device 1701 coupled with the processor 1720, and may perform various data processing or computation. According to an embodiment, as at least part of the data processing or computation, the processor 1720 may store a command or data received from another component (e.g., the sensor module 1776 or the communication module 1790) in volatile memory 1732, process the command or the data stored in the volatile memory 1732, and store resulting data in non-volatile memory 1734. According to an embodiment, the processor 1720 may include a main processor 1721 (e.g., a central processing unit (CPU) or an application processor (AP)), or an auxiliary processor 1723 (e.g., a graphics processing unit (GPU), a neural processing unit (NPU), an image signal processor (ISP), a sensor hub processor, or a communication processor (CP)) that is operable independently from, or in conjunction with, the main processor 1721. For example, when the electronic device 1701 includes the main processor 1721 and the auxiliary processor 1723, the auxiliary processor 1723 may be adapted to consume less power than the main processor 1721, or to be specific to a specified function. The auxiliary processor 1723 may be implemented as separate from, or as part of the main processor 1721.

The auxiliary processor 1723 may control at least some of functions or states related to at least one component (e.g., the display module 1760, the sensor module 1776, or the communication module 1790) among the components of the electronic device 1701, instead of the main processor 1721 while the main processor 1721 is in an inactive (e.g., sleep) state, or together with the main processor 1721 while the main processor 1721 is in an active state (e.g., executing an application). According to an embodiment, the auxiliary processor 1723 (e.g., an image signal processor or a communication processor) may be implemented as part of another component (e.g., the camera module 1780 or the communication module 1790) functionally related to the auxiliary processor 1723. According to an embodiment, the auxiliary processor 1723 (e.g., the neural processing unit) may include a hardware structure specified for artificial intelligence model processing. An artificial intelligence model may be generated by machine learning. Such learning may be performed, e.g., by the electronic device 1701 where the artificial intelligence is performed or via a separate server (e.g., the server 1708). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1730 may store various data used by at least one component (e.g., the processor 1720 or the sensor module 1776) of the electronic device 1701. The various data may include, for example, software (e.g., the program 1740) and input data or output data for a command related thereto. The memory 1730 may include the volatile memory 1732 or the non-volatile memory 1734.

The program 1740 may be stored in the memory 1730 as software, and may include, for example, an operating system (OS) 1742, middleware 1744, or an application 1746.

The input module 1750 may receive a command or data to be used by another component (e.g., the processor 1720) of the electronic device 1701, from the outside (e.g., a user) of the electronic device 1701. The input module 1750 may include, for example, a microphone, a mouse, a keyboard, a key (e.g., a button), or a digital pen (e.g., a stylus pen).

The sound output module 1755 may output sound signals to the outside of the electronic device 1701. The sound output module 1755 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1760 may visually provide information to the outside (e.g., a user) of the electronic device 1701. The display module 1760 may include, for example, a display, a hologram device, or a projector and control circuitry to control a corresponding one of the display, hologram device, and projector. According to an embodiment, the display module 1760 may include a touch sensor adapted to detect a touch, or a pressure sensor adapted to measure the intensity of force incurred by the touch.

The audio module 1770 may convert a sound into an electrical signal and vice versa. According to an embodiment, the audio module 1770 may obtain the sound via the input module 1750, or output the sound via the sound output module 1755 or a headphone of an external electronic device (e.g., an electronic device 1702) directly (e.g., wiredly) or wirelessly coupled with the electronic device 1701.

The sensor module 1776 may detect an operational state (e.g., power or temperature) of the electronic device 1701 or an environmental state (e.g., a state of a user) external to the electronic device 1701, and then generate an electrical signal or data value corresponding to the detected state. According to an embodiment, the sensor module 1776 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1777 may support one or more specified protocols to be used for the electronic device 1701 to be coupled with the external electronic device (e.g., the electronic device 1702) directly (e.g., wiredly) or wirelessly. According to an embodiment, the interface 1777 may include, for example, a high definition multimedia interface (HDMI), a universal serial bus (USB) interface, a secure digital (SD) card interface, or an audio interface.

A connecting terminal 1778 may include a connector via which the electronic device 1701 may be physically connected with the external electronic device (e.g., the electronic device 1702). According to an embodiment, the connecting terminal 1778 may include, for example, an HDMI connector, a USB connector, an SD card connector, or an audio connector (e.g., a headphone connector).

The haptic module 1779 may convert an electrical signal into a mechanical stimulus (e.g., a vibration or a movement) or electrical stimulus which may be recognized by a user via his tactile sensation or kinesthetic sensation. According to an embodiment, the haptic module 1779 may include, for example, a motor, a piezoelectric element, or an electric stimulator.

The camera module 1780 may capture a still image or moving images. According to an embodiment, the camera module 1780 may include one or more lenses, image sensors, image signal processors, or flashes.

The power management module 1788 may manage power supplied to the electronic device 1701. According to an embodiment, the power management module 1788 may be implemented as at least part of, for example, a power management integrated circuit (PMIC).

The battery 1789 may supply power to at least one component of the electronic device 1701. According to an embodiment, the battery 1789 may include, for example, a primary cell which is not rechargeable, a secondary cell which is rechargeable, or a fuel cell.

The communication module 1790 may support establishing a direct (e.g., wired) communication channel or a wireless communication channel between the electronic device 1701 and the external electronic device (e.g., the electronic device 1702, the electronic device 1704, or the server 1708) and performing communication via the established communication channel. The communication module 1790 may include one or more communication processors that are operable independently from the processor 1720 (e.g., the application processor (AP)) and supports a direct (e.g., wired) communication or a wireless communication. According to an embodiment, the communication module 1790 may include a wireless communication module 1792 (e.g., a cellular communication module, a short-range wireless communication module, or a global navigation satellite system (GNSS) communication module) or a wired communication module 1794 (e.g., a local area network (LAN) communication module or a power line communication (PLC) module). A corresponding one of these communication modules may communicate with the external electronic device via the first network 1798 (e.g., a short-range communication network, such as Bluetooth™, wireless-fidelity (Wi-Fi) direct, or infrared data association (IrDA)) or the second network 1799 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1792 may identify and authenticate the electronic device 1701 in a communication network, such as the first network 1798 or the second network 1799, using subscriber information (e.g., international mobile subscriber identity (IMSI)) stored in the subscriber identification module 1796.

The wireless communication module 1792 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1792 may support a high-frequency band (e.g., the millimeter wave (mmWave) band) to achieve, e.g., a high data transmission rate. The wireless communication module 1792 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1792 may support various requirements specified in the electronic device 1701, an external electronic device (e.g., the electronic device 1704), or a network system (e.g., the second network 1799). According to an embodiment, the wireless communication module 1792 may support a peak data rate (e.g., 20 Gbps or more) for implementing eMBB, loss coverage (e.g., 1764 dB or less) for implementing mMTC, or user plane (U-plane) latency (e.g., 0.5 ms or less for each of downlink (DL) and uplink (UL), or a round trip of 17 ms or less) for implementing URLLC.

The antenna module 1797 may transmit or receive a signal or power to or from the outside (e.g., the external electronic device) of the electronic device 1701. According to an embodiment, the antenna module 1797 may include an antenna including a radiating element composed of a conductive material or a conductive pattern formed in or on a substrate (e.g., a printed circuit board (PCB)). According to an embodiment, the antenna module 1797 may include a plurality of antennas (e.g., array antennas). In such a case, at least one antenna appropriate for a communication scheme used in the communication network, such as the first network 1798 or the second network 1799, may be selected, for example, by the communication module 1790 (e.g., the wireless communication module 1792) from the plurality of antennas. The signal or the power may then be transmitted or received between the communication module 1790 and the external electronic device via the selected at least one antenna. According to an embodiment, another component (e.g., a radio frequency integrated circuit (RFIC)) other than the radiating element may be additionally formed as part of the antenna module 1797.

According to various embodiments, the antenna module 1797 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1701 and the external electronic device 1704 via the server 1708 coupled with the second network 1799. Each of the electronic devices 1702 or 1704 may be a device of a same type as, or a different type, from the electronic device 1701. According to an embodiment, all or some of operations to be executed at the electronic device 1701 may be executed at one or more of the external electronic devices 1702, 1704, or the server 1708. For example, if the electronic device 1701 should perform a function or a service automatically, or in response to a request from a user or another device, the electronic device 1701, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1701. The electronic device 1701 may provide the outcome, with or without further processing of the outcome, as at least part of a reply to the request. To that end, a cloud computing, distributed computing, mobile edge computing (MEC), or client-server computing technology may be used, for example. The electronic device 1701 may provide ultra low-latency services using, e.g., distributed computing or mobile edge computing. In another embodiment, the external electronic device 1704 may include an internet-of-things (IoT) device. The server 1708 may be an intelligent server using machine learning and/or a neural network. According to an embodiment, the external electronic device 1704 or the server 1708 may be included in the second network 1799. The electronic device 1701 may be applied to intelligent services (e.g., smart home, smart city, smart car, or healthcare) based on 5G communication technology or IoT-related technology.

FIG. 18 is a block diagram 1800 illustrating the display module 1760 according to an embodiment of the disclosure.

Referring to FIG. 18, the display module 1760 may include a display 1810 and a display driver integrated circuit (DDI) 1830 to control the display 1810. The DDI 1830 may include an interface module 1831, memory 1833 (e.g., buffer memory), an image processing module 1835, or a mapping module 1837. The DDI 1830 may receive image information that contains image data or an image control signal corresponding to a command to control the image data from another component of the electronic device 1701 via the interface module 1831. For example, according to an embodiment, the image information may be received from the processor 1720 (e.g., the main processor 1721 (e.g., an application processor)) or the auxiliary processor 1723 (e.g., a graphics processing unit) operated independently from the function of the main processor 1721. The DDI 1830 may communicate, for example, with touch circuitry 1850 or the sensor module 1776 via the interface module 1831. The DDI 1830 may also store at least part of the received image information in the memory 1833, for example, on a frame by frame basis. The image processing module 1835 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 1810. The mapping module 1837 may generate a voltage value or a current value corresponding to the image data pre-processed or post-processed by the image processing module 1835. According to an embodiment, the generating of the voltage value or current value may be performed, for example, based at least in part on one or more attributes of the pixels (e.g., an array, such as a red green blue (RGB) stripe or a pentile structure, of the pixels, or the size of each subpixel). At least some pixels of the display 1810 may be driven, for example, based at least in part on the voltage value or the current value such that visual information (e.g., a text, an image, or an icon) corresponding to the image data may be displayed via the display 1810.

According to an embodiment, the display module 1760 may further include the touch circuitry 1850. The touch circuitry 1850 may include a touch sensor 1851 and a touch sensor IC 1853 to control the touch sensor 1851. The touch sensor IC 1853 may control the touch sensor 1851 to sense a touch input or a hovering input with respect to a certain position on the display 1810. To achieve this, for example, the touch sensor 1851 may detect (e.g., measure) a change in a signal (e.g., a voltage, a quantity of light, a resistance, or a quantity of one or more electric charges) corresponding to the certain position on the display 1810. The touch circuitry 1850 may provide input information (e.g., a position, an area, a pressure, or a time) indicative of the touch input or the hovering input detected via the touch sensor 1851 to the processor 1720. According to an embodiment, at least part (e.g., the touch sensor IC 1853) of the touch circuitry 1850 may be formed as part of the display 1810 or the DDI 1830, or as part of another component (e.g., the auxiliary processor 1723) disposed outside the display module 1760.

According to an embodiment, the display module 1760 may further include at least one sensor (e.g., a fingerprint sensor, an iris sensor, a pressure sensor, or an illuminance sensor) of the sensor module 1776 or a control circuit for the at least one sensor. In such a case, the at least one sensor or the control circuit for the at least one sensor may be embedded in one portion of a component (e.g., the display 1810, the DDI 1830, or the touch circuitry 1850)) of the display module 1760. For example, when the sensor module 1776 embedded in the display module 1760 includes a biometric sensor (e.g., a fingerprint sensor), the biometric sensor may obtain biometric information (e.g., a fingerprint image) corresponding to a touch input received via a portion of the display 1810. As another example, when the sensor module 1776 embedded in the display module 1760 includes a pressure sensor, the pressure sensor may obtain pressure information corresponding to a touch input received via a partial or whole area of the display 1810. According to an embodiment, the touch sensor 1851 or the sensor module 1776 may be disposed between pixels in a pixel layer of the display 1810, or over or under the pixel layer.

The technical problems to be achieved in this document are not limited to those described above, and other technical problems not mentioned herein will be clearly understood by those having ordinary knowledge in the art to which the disclosure belongs, from the following description.

As described above, an electronic device (e.g., the electronic device 100) may include at least one processor (e.g., at least one processor 110) comprising processing circuitry, a display (e.g., the display 130) including display driving circuitry (e.g., the display driving circuitry 131) and a display panel (e.g., the display panel 132), and memory (e.g., the memory 120), comprising one or more storage media, storing instructions. The instructions, when executed by the at least one processor individually or collectively, may cause the electronic device to generate, while a first image is displayed on the display panel, a notification for an image transmission to the display driving circuitry to be executed from a first start time different from a second start time that is determined according to a frame interval, generate a command according to the notification, and control, according to the command, the display driving circuitry to complete a repeated display of the first image on the display panel before the data for a second image is transmitted to the display driving circuitry through the image transmission executed from the first start time.

The memory may store a first program included in a hardware abstraction layer (HAL) for controlling the display and a second program included in a framework layer for controlling the display. The first program may include a portion of the instructions, and the second program may include another portion of the instructions. The notification may be generated by the second program, and the command may be generated by the first program in response to the notification from the second program.

The at least one processor may include a central processing unit (CPU) (e.g., the CPU 111) including processing circuitry and a display processing unit (DPU) (e.g., the DPU 112) including processing circuitry. The instructions, when executed by the at least one processor individually or collectively, may cause the electronic device to generate the notification and the command by using the CPU, and control, by transmitting the command to the display driving circuitry through the DPU, the display driving circuitry to complete the repeated display of the first image on the display panel, before the data for the second image is transmitted to the display driving circuitry through the image transmission executed from the first start time.

The display driving circuitry may include graphic random access memory (GRAM). The display driving circuitry may be configured to according to the command received from the at least one processor, complete, before the data for the second image is transmitted through the image transmission executed from the first start time to the display driving circuitry according to a command mode of mobile industry processor interface (MIPI) display serial interface (DSI), the repeated display of the first image by scanning the first image stored in the GRAM.

The display driving circuitry may be configured to change, according to the command, a start time of an image transmission determined according to the frame interval from the second start time to the first start time, and complete, based on changing the start time from the second start time to the first start time, the repeated display of the first image by scanning the first image stored in the GRAM, before the data for the second image is transmitted to the display driving circuitry through the image transmission executed from the first start time according to the command mode.

The instructions, when executed by the at least one processor individually or collectively, may cause the electronic device to generate the notification and the command by using the CPU, and control, by transmitting the command to the DPU using the CPU, the display driving circuitry to complete the repeated display of the first image on the display panel, before the data for the second image is transmitted to the display driving circuitry through the image transmission executed from the first start time.

The instructions, when executed by the at least one processor individually or collectively, may cause the electronic device to, based on the command transmitted from the CPU to the DPU, control, by transmitting data for the first image obtained from the memory using the DPU to the display driving circuitry according to a video mode of mobile industry processor interface (MIPI) display serial interface (DSI), the display driving circuitry to complete, before the data for the second image is transmitted through the image transmission executed from the first start time to the display driving circuitry according to the video mode, the repeated display of the first image.

The instructions, when executed by the at least one processor individually or collectively, may cause the electronic device to, according to the command, change, using the DPU, a start time of an image transmission determined according to the frame interval from the second start time to the first start time, and control, by transmitting the data for the first image to the display driving circuitry according to the video mode using the DPU based on changing the start time from the second start time to the first start time, the display driving circuitry to complete, before the data for the second image is transmitted through the image transmission executed from the first start time to the display driving circuitry according to the video mode, the repeated display of the first image.

The instructions, when executed by the at least one processor individually or collectively, may cause the electronic device to generate, using the CPU, the notification and the command, by transmitting, while the GRAM is enabled according to a video hybrid mode of mobile industry processor interface (MIPI) display serial interface (DSI), the command through the DPU to the display driving circuitry, control the display driving circuitry to complete, before the data for the second image is transmitted through the image transmission executed from the first start time to the display driving circuitry according to the video hybrid mode, the repeated display of the first image on the display panel, and by transmitting, while the GRAM is disabled according to the video hybrid mode, the command to the DPU using the CPU, control the display driving circuitry to complete, before the data for the second image is transmitted through the image transmission executed from the first start time to the display driving circuitry according to the video hybrid mode, the repeated display of the first image on the display panel.

The display driving circuitry may be configured to, while the GRAM is enabled according to the video hybrid mode, receive, through the DPU from the CPU, the command, and according to the command, complete, before the data for the second image is transmitted through the image transmission executed from the first start time to the display driving circuitry according to the video hybrid mode, the repeated display of the first image by scanning the first image stored in the GRAM.

The instructions, when executed by the at least one processor individually or collectively, may cause the electronic device to, while the GRAM is disabled according to the video hybrid mode, control, by transmitting, to the display driving circuitry according to the video hybrid mode, data for the first image obtained from the memory using the DPU based on the command transmitted from the CPU to the DPU, the display driving circuitry to complete, before the data for the second image is transmitted through the image transmission executed from the first start time to the display driving circuitry according to the video hybrid mode, the repeated display of the first image.

The display driving circuitry may be configured to, while the GRAM is enabled according to the video hybrid mode, according to the command, change a start time of an image transmission determined according to the frame interval from the second start time to the first start time, and based on changing the start time from the second start time to the first start time, complete, before the data for the second image is transmitted through the image transmission executed from the first start time to the display driving circuitry according to the video hybrid mode, the repeated display of the first image by scanning the first image stored in the GRAM. The instructions, when executed by the at least one processor individually or collectively, may cause the electronic device to, while the GRAM is disabled according to the video hybrid mode, according to the command, change, using the DPU, a start time of an image transmission determined according to the frame interval from the second start time to the first start time, and by transmitting the data for the first image to the display driving circuitry according to the video hybrid mode, using the DPU, based on changing the start time from the second start time to the first start time, control the display driving circuitry to complete, before the data for the second image is transmitted through the image transmission executed from the first start time to the display driving circuitry according to the video hybrid mode, the repeated display of the first image.

As described above, an electronic device (e.g., the electronic device 100) may include at least one processor (e.g., at least one processor 110) comprising processing circuitry, a display (e.g., the display 130) including display driving circuitry (e.g., the display driving circuitry 131) and a display panel (e.g., the display panel 132), and memory (e.g., the memory 120), comprising one or more storage media, storing instructions. The instructions, when executed by the at least one processor individually or collectively, may cause the electronic device to generate, while a first image is displayed on the display panel, a notification for an image transmission to the display driving circuitry to be executed from a first start time different from a second start time that is determined according to a frame interval, generate a command according to the notification, and control, according to the command, the display driving circuitry to refrain from performing a repeated display of the first image on the display panel before the data for a second image is transmitted to the display driving circuitry through the image transmission executed from the first start time.

The memory may store a first program included in a hardware abstraction layer (HAL) for controlling the display and a second program included in a framework layer for controlling the display. The first program 191 may include a portion of the instructions, and the second program may include another portion of the instructions. The notification may be generated by the second program, and the command may be generated by the first program 191 in response to the notification from the second program.

The instructions, when executed by the at least one processor individually or collectively, may cause the electronic device to detect that the data for the second image is not transmitted to the display driving circuitry through the image transmission executed from the first start time, and control the display driving circuitry to resume performing the repeated display of the first image refrained according to the command, based on the detection.

The at least one processor may include a central processing unit (CPU) (e.g., the CPU 111) including processing circuitry and a display processing unit (DPU) (e.g., the DPU 112) including processing circuitry. The instructions, when executed by the at least one processor individually or collectively, may cause the electronic device to generate the notification and the command by using the CPU, and control, by transmitting the command to the display driving circuitry through the DPU, the display driving circuitry to refraim from performing the repeated display of the first image on the display panel, before the data for the second image is transmitted to the display driving circuitry through the image transmission executed from the first start time.

The instructions, when executed by the at least one processor individually or collectively, may cause the electronic device to generate the notification and the command by using the CPU, and by transmitting the command to the DPU using the CPU, control the display driving circuitry to refrain from the repeated display of the first image on the display panel, before the data for the second image is transmitted to the display driving circuitry through the image transmission executed from the first start time.

As described above, an electronic device (e.g., the electronic device 100) may include at least one processor (e.g., the at least one processor 110) including processing circuitry, a display (e.g., the display 130) including display driving circuitry (e.g., the display driving circuitry 131) and a display panel (e.g., the display panel 132), and memory (e.g., the memory 120), including one or more storage media, storing instructions. The instructions, when executed by the at least one processor individually or collectively, may cause the electronic device to generate, while a first image is displayed on the display panel, a notification for an image transmission to the display driving circuitry to be executed from a first start time different from a second start time that is determined according to a frame interval, generate, according to the notification, a first command based on the notification generated outside a reference time interval from the first start time, and control the display driving circuitry to complete a repeated display of the first image on the display panel before data for a second image is transmitted to the display driving circuitry through the image transmission executed from the first start time, according to the first command, and generate, according to the notification, a second command based on the notification generated within the reference time interval from the first start time, and control the display driving circuitry to refrain from performing the repeated display of the first image on the display panel before the data for the second image is transmitted to the display driving circuitry through the image transmission executed from the first start time, according to the second command.

The memory may store a first program included in a hardware abstraction layer (HAL) for controlling the display and a second program included in a framework layer for controlling the display. The first program may include a portion of the instructions, and the second program may include another portion of the instructions. The notification may be generated by the second program, and the first command and the second command may be generated by the first program, in response to the notification from the second program.

The instructions, when executed by the at least one processor individually or collectively, may cause the electronic device to detect that the data for the second image is not transmitted to the display driving circuitry through the image transmission executed from the first start time, and control the display driving circuitry to resume performing the repeated display of the first image refrained according to the second command, based on the detection.

The effects that can be obtained from the disclosure are not limited to those described above, and any other effects not mentioned herein will be clearly understood by those having ordinary knowledge in the art to which the disclosure belongs, from the following description.

A method according to an embodiment may be implemented in a form of program command executable through various computer means and may be recorded on a computer-readable medium. In this case, the medium may continuously store a program executable by a computer or may temporarily store for execution or download. In addition, the medium may be various recording means or storage means in a form in which single or multiple pieces of hardware are combined, and may not be limited to a medium directly connected to any computer system, and may be distributed on a network.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1740) including one or more instructions that are stored in a storage medium (e.g., internal memory 1736 or external memory 1738) that is readable by a machine (e.g., the electronic device 1701). For example, a processor (e.g., the processor 1720) of the machine (e.g., the electronic device 1701) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a display including display driving circuitry and a display panel; and
memory, comprising one or more storage media, storing instructions; and
at least one processor comprising processing circuitry,
wherein the instructions, when executed by the at least one processor individually or collectively, cause the electronic device to:
while a first image is displayed on the display panel, generate a notification for an image transmission to the display driving circuitry to be executed from a first start time different from a second start time that is determined according to a frame interval,
generate a command according to the notification, and
control, according to the command, the display driving circuitry to complete, before data for a second image is transmitted through the image transmission executed from the first start time to the display driving circuitry, a repeated display of the first image on the display panel.

2. The electronic device of claim 1,
wherein the memory stores:
a first program included in a hardware abstraction layer (HAL) to control the display, and
a second program included in a framework layer to control the display,
wherein the first program includes a portion of the instructions,
wherein the second program includes another portion of the instructions,
wherein the notification is generated by the second program, and
wherein the command is generated by the first program in response to the notification from the second program.

3. The electronic device of claim 1,
wherein the at least one processor includes:
a central processing unit (CPU) comprising processing circuitry, and
a display processing unit (DPU) comprising processing circuitry, and
wherein the instructions, when executed by the at least one processor individually or collectively, cause the electronic device to:
generate, using the CPU, the notification and the command, and
control, by transmitting the command through the DPU to the display driving circuitry, the display driving circuitry to complete, before the data for the second image is transmitted through the image transmission executed from the first start time to the display driving circuitry, the repeated display of the first image on the display panel.

4. The electronic device of claim 3,
wherein the display driving circuitry includes a graphic random access memory (GRAM), and
wherein the display driving circuitry is configured to:
according to the command received from the at least one processor, complete, before the data for the second image is transmitted through the image transmission executed from the first start time to the display driving circuitry according to a command mode of mobile industry processor interface (MIPI) display serial interface (DSI), the repeated display of the first image by scanning the first image stored in the GRAM.

5. The electronic device of claim 4, wherein the display driving circuitry is configured to:
according to the command, change a start time of an image transmission determined according to the frame interval from the second start time to the first start time; and
based on changing the start time from the second start time to the first start time, complete, before the data for the second image is transmitted through the image transmission executed from the first start time to the display driving circuitry according to the command mode, the repeated display of the first image by scanning the first image stored in the GRAM.

6. The electronic device of claim 1,
wherein the at least one processor includes:
a central processing unit (CPU) comprising processing circuitry, and
a display processing unit (DPU) comprising processing circuitry, and
wherein the instructions, when executed by the at least one processor individually or collectively, cause the electronic device to:
generate, using the CPU, the notification and the command, and
control, by transmitting the command to the DPU using the CPU, the display driving circuitry to complete, before the data for the second image is transmitted through the image transmission executed from the first start time to the display driving circuitry, the repeated display of the first image on the display panel.

7. The electronic device of claim 6, wherein the instructions, when executed by the at least one processor individually or collectively, cause the electronic device to:
based on the command transmitted from the CPU to the DPU, control, by transmitting data for the first image obtained from the memory using the DPU to the display driving circuitry according to a video mode of mobile industry processor interface (MIPI) display serial interface (DSI), the display driving circuitry to complete, before the data for the second image is transmitted through the image transmission executed from the first start time to the display driving circuitry according to the video mode, the repeated display of the first image.

8. The electronic device of claim 7, wherein the instructions, when executed by the at least one processor individually or collectively, cause the electronic device to:
according to the command, change, using the DPU, a start time of an image transmission determined according to the frame interval from the second start time to the first start time, and
control, by transmitting the data for the first image to the display driving circuitry according to the video mode using the DPU based on changing the start time from the second start time to the first start time, the display driving circuitry to complete, before the data for the second image is transmitted through the image transmission executed from the first start time to the display driving circuitry according to the video mode, the repeated display of the first image.

9. The electronic device of claim 1,
wherein the at least one processor includes:
a central processing unit (CPU) comprising processing circuitry, and
a display processing unit (DPU) comprising processing circuitry,
wherein the display driving circuitry includes a graphic random access memory (GRAM), and
wherein the instructions, when executed by the at least one processor individually or collectively, cause the electronic device to:
generate, using the CPU, the notification and the command,
by transmitting, while the GRAM is enabled according to a video hybrid mode of mobile industry processor interface (MIPI) display serial interface (DSI), the command through the DPU to the display driving circuitry, control the display driving circuitry to complete, before the data for the second image is transmitted through the image transmission executed from the first start time to the display driving circuitry according to the video hybrid mode, the repeated display of the first image on the display panel, and
by transmitting, while the GRAM is disabled according to the video hybrid mode, the command to the DPU using the CPU, control the display driving circuitry to complete, before the data for the second image is transmitted through the image transmission executed from the first start time to the display driving circuitry according to the video hybrid mode, the repeated display of the first image on the display panel.

10. The electronic device of claim 9, wherein the display driving circuitry is configured to:
while the GRAM is enabled according to the video hybrid mode:
receive, through the DPU from the CPU, the command, and
according to the command, complete, before the data for the second image is transmitted through the image transmission executed from the first start time to the display driving circuitry according to the video hybrid mode, the repeated display of the first image by scanning the first image stored in the GRAM.

11. The electronic device of claim 9, wherein the instructions, when executed by the at least one processor individually or collectively, cause the electronic device to:
while the GRAM is disabled according to the video hybrid mode, control, by transmitting, to the display driving circuitry according to the video hybrid mode, data for the first image obtained from the memory using the DPU based on the command transmitted from the CPU to the DPU, the display driving circuitry to complete, before the data for the second image is transmitted through the image transmission executed from the first start time to the display driving circuitry according to the video hybrid mode, the repeated display of the first image.

12. The electronic device of claim 9,
wherein the display driving circuitry is configured to:
while the GRAM is enabled according to the video hybrid mode:
according to the command, change a start time of an image transmission determined according to the frame interval from the second start time to the first start time, and
based on changing the start time from the second start time to the first start time, complete, before the data for the second image is transmitted through the image transmission executed from the first start time to the display driving circuitry according to the video hybrid mode, the repeated display of the first image by scanning the first image stored in the GRAM, and
wherein the instructions, when executed by the at least one processor individually or collectively, cause the electronic device to:
while the GRAM is disabled according to the video hybrid mode:
according to the command, change, using the DPU, a start time of an image transmission determined according to the frame interval from the second start time to the first start time, and
by transmitting the data for the first image to the display driving circuitry according to the video hybrid mode, using the DPU, based on changing the start time from the second start time to the first start time, control the display driving circuitry to complete, before the data for the second image is transmitted through the image transmission executed from the first start time to the display driving circuitry according to the video hybrid mode, the repeated display of the first image.

13. An electronic device comprising:
a display including display driving circuitry and a display panel;
memory, comprising one or more storage media, storing instructions; and
at least one processor comprising processing circuitry,
wherein the instructions, when executed by the at least one processor individually or collectively, cause the electronic device to:
while a first image is displayed on the display panel, generate a notification for an image transmission to the display driving circuitry to be executed from a first start time different from a second start time that is determined according to a frame interval,
generate a command according to the notification, and
control, according to the command, the display driving circuitry to refrain from, before data for a second image is transmitted through the image transmission executed from the first start time to the display driving circuitry, performing a repeated display of the first image on the display panel.

14. The electronic device of claim 13,
wherein the memory stores:
a first program included in a hardware abstraction layer (HAL) to control the display, and
a second program included in a framework layer to control the display,
wherein the first program includes a portion of the instructions,
wherein the second program includes another portion of the instructions,
wherein the notification is generated by the second program, and
wherein the command is generated by the first program in response to the notification from the second program.

15. The electronic device of claim 13, wherein the instructions, when executed by the at least one processor individually or collectively, cause the electronic device to:
detect that the data for the second image is not transmitted through the image transmission executed from the first start time to the display driving circuitry; and
according to the detection, control the display driving circuitry to resume performing the repeated display of the first image refrained according to the command.

16. The electronic device of claim 13,
wherein the at least one processor includes:
a central processing unit (CPU) comprising processing circuitry, and
a display processing unit (DPU) comprising processing circuitry, and
wherein the instructions, when executed by the at least one processor individually or collectively, cause the electronic device to:
generate, using the CPU, the notification and the command, and
control, by transmitting the command through the DPU to the display driving circuitry, the display driving circuitry to refrain from, before the data for the second image is transmitted through the image transmission executed from the first start time to the display driving circuitry, performing the repeated display of the first image on the display panel.

17. The electronic device of claim 13,
wherein the at least one processor includes:
a central processing unit (CPU) comprising processing circuitry, and
a display processing unit (DPU) comprising processing circuitry, and
wherein the instructions, when executed by the at least one processor individually or collectively, cause the electronic device to:
generate, using the CPU, the notification and the command, and
control, by transmitting the command to the DPU using the CPU, the display driving circuitry to refrain from, before the data for the second image is transmitted through the image transmission executed from the first start time to the display driving circuitry, performing the repeated display of the first image on the display panel.

18. An electronic device comprising:
a display including display driving circuitry and a display panel;
memory, comprising one or more storage media, storing instructions; and
at least one processor comprising processing circuitry, when executed by the at least one processor individually or collectively, that cause the electronic device to:
while a first image is displayed on the display panel, generate a notification for an image transmission to the display driving circuitry to be executed from a first start time different from a second start time that is determined according to a frame interval,
based on the notification generated outside a reference time interval from the first start time:
generate a first command according to the notification, and
control, according to the first command, the display driving circuitry to complete, before data for a second image is transmitted through the image transmission executed from the first start time to the display driving circuitry, a repeated display of the first image on the display panel, and
based on the notification generated inside the reference time interval from the first start time:
generate a second command according to the notification, and
control, according to the second command, the display driving circuitry to refrain from, before the data for the second image is transmitted through the image transmission executed from the first start time to the display driving circuitry, performing the repeated display of the first image on the display panel.

19. The electronic device of claim 18,
wherein the memory stores:
a first program included in a hardware abstraction layer (HAL) to control the display, and
a second program included in a framework layer to control the display,
wherein the first program includes a portion of the instructions,
wherein the second program includes another portion of the instructions,
wherein the notification is generated by the second program, and
wherein the command is generated by the first program in response to the notification from the second program.

20. The electronic device of claim 18, wherein the instructions, when executed by the at least one processor individually or collectively, further cause the electronic device to:
detect that the data for the second image is not transmitted through the image transmission executed from the first start time to the display driving circuitry; and
according to the detection, control the display driving circuitry to resume performing the repeated display of the first image refrained according to the second command.
